(19) United States
(12) Patent Application Publication
(10) Pub. No.: US 2025/0363219 A1
(43) Pub. Date: Nov. 27, 2025

(54) DEVICES, SYSTEMS, AND METHODS FOR CATEGORIZING, PRIORITIZING, AND MITIGATING CYBER SECURITY RISKS

(71) Applicant: BlueVoyant LLC, New York, NY (US)

(72) Inventors: Brian Keller, New York, NY (US); Ryan C. Agee, Millersville, MD (US); Michael Spencer, New York, NY (US); John Reel, New York, NY (US); Brandon Beaty, New York, NY (US)

(73) Assignee: BlueVoyant LLC, New York, NY (US)

(21) Appl. No.: 18/872,343

(22) PCT Filed: Jun. 16, 2023
(86) PCT No.: PCT/US2023/068590

§ 371 Date: Dec. 6, 2024

Related U.S. Application Data
(60) Provisional application No. 63/353,992, filed on Jun. 21, 2022.

(51) Int. Cl. G06F 21/57; G06F 21/55

(52) U.S. Cl. CPC G06F 21/577; G06F 21/552

(57) ABSTRACT

A method for managing cyber security risk for a client entity communicating with a plurality of target entities is disclosed. In one aspect, the method includes identifying a plurality of cyber asset footprints, wherein each cyber asset footprint comprises cyber assets associated with a different one of the target entities. In another aspect, the method includes monitoring a plurality of data sources comprising cyber security risk information to generate source data, wherein the source data is organized based on a plurality of risk factors, and wherein the risk factors are classified according to a cyber security risk taxonomy. In yet another aspect, the method includes identifying relevant observations in the source data, wherein each relevant observation comprises information related to one the risk factors, and wherein each relevant observation is identified based on a correlation between the information related to the risk factor and one of the cyber asset footprints.

### CROSS-REFERENCE TO RELATED APPLICATIONS

The present application is related to U.S. Provisional Patent Application No. 63/353,992, titled DEVICES, SYSTEMS, AND METHODS FOR CATEGORIZING, PRIORITIZING, AND MITIGATING CYBER SECURITY RISKS, filed Jun. 21, 2022, the disclosure of which is incorporated by reference in its entirety herein.

### FIELD

The present disclosure is generally related to computer security, and, more particularly, is directed to improved devices, systems, and methods for categorizing, prioritizing, and mitigating cyber security risks for a client entity communicating with a plurality of target entities.

### SUMMARY

The following summary is provided to facilitate an understanding of some of the innovative features unique to the aspects disclosed herein, and it is not intended to be a full description. A full appreciation of the various aspects can be gained by taking the entire specification, claims, and abstract as a whole.

In various aspects, a method for managing cyber security risk for a client entity communicating with a plurality of target entities is disclosed. In one aspect, the method includes identifying a plurality of cyber asset footprints, wherein each cyber asset footprint comprises cyber assets associated with a different one of the target entities. In another aspect, the method includes monitoring a plurality of data sources comprising cyber security risk information to generate source data, wherein the source data is organized based on a plurality of cyber security risk factors, and wherein the risk factors are classified according to taxonomy branches comprising: information technology (IT) hygiene; vulnerabilities; threat activity; and malicious activity. In yet another aspect, the method includes identifying relevant observations in the source data, wherein each relevant observation comprises information related to one the risk factors, and wherein each relevant observation is identified based on a correlation between the information related to the risk factor and one of the cyber asset footprints; determining that one of the relevant observations does not comply with a predetermined metric of a plurality of predetermined metrics, wherein each of the predetermined metrics is associated with one of the risk factors; issuing a finding based on determining the relevant observation does not comply with the predetermined metric; and transmitting an alert to the client entity based on the taxonomy branch of the risk factor associated with the finding.

In various aspects, a method for managing cyber security risk for a client entity communicating with a plurality of target entities is disclosed. In one aspect, the method includes identifying a plurality of cyber asset footprints, wherein each cyber asset footprint comprises cyber assets associated with a different one of the target entities. In another aspect, the method includes monitoring a plurality of data sources comprising cyber risk information to generate source data, wherein the source data is organized based on a plurality of risk factors, and wherein the risk factors are classified according to a risk factor taxonomy. In yet another aspect, the method includes identifying relevant observations in the source data, wherein each relevant observation comprises information related to one of the risk factors, and wherein each relevant observation is identified based on a correlation between the information related to the risk factor and one of the cyber asset footprints; determining that one of the relevant observations does not comply with a predetermined metric of a plurality of predetermined metrics, wherein each of the predetermined metrics is associated with one of the risk factors; and issuing a finding based on determining the relevant observation does not comply with the predetermined metric.

These, and other objects, features, and characteristics of the present disclosure, as well as the methods of operation, functions of the related elements of structure, the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration and description only, and they are not intended as a definition of the limits of the disclosure.

### BRIEF DESCRIPTION OF THE DRAWINGS

Various features of the aspects described herein are set forth with particularity in the appended claims. The various aspects, however, both as to organization and methods of operation, together with the advantages thereof, may be understood in accordance with the following description taken in conjunction with the accompanying drawings as follows:

FIG. 1 illustrates a diagram of a system configured for identifying cyber assets and generating cyber risk mitigation actions for a plurality of entities, in accordance with at least one non-limiting aspect of the present disclosure;

FIG. 2 illustrates a flow chart of a process for identifying cyber assets associated with a plurality of entities, in accordance with at least one non-limiting aspect of the present disclosure;

FIG. 3 illustrates a flow chart of a process for generating cyber risk mitigation actions across a plurality of entities based on the cyber assets identified in FIG. 2, in accordance with at least one non-limiting aspect of the present disclosure;

FIG. 4 illustrates a diagram of a system configured for identifying cyber assets and generating cyber risk mitigation actions for a plurality of entities based on a risk factor taxonomy, in accordance with at least one non-limiting aspect of the present disclosure;

FIG. 5 illustrates a flow chart of a process for managing cyber risk based on a risk factor taxonomy, in accordance with at least one non-limiting aspect of the present disclosure;

FIGS. 6A-6B illustrate an example of a cyber security risk taxonomy employed by the process for managing cyber risk illustrated in FIG. 5, in accordance with at least one non-limiting aspect of the present disclosure;

FIG. 7 illustrates an example of a graphical user interface displaying an entity cyber security risk report, in accordance with at least one non-limiting aspect of the present disclosure;

FIG. 8 illustrates an example of a graphical user interface displaying an entity cyber security risk report, in accordance with at least one non-limiting aspect of the present disclosure;

FIG. 9 illustrates a flow chart of a process for initiating remediation actions based on a cyber security risk factor taxonomy, in accordance with at least one non-limiting aspect of the present disclosure;

FIG. 10 illustrates a diagram of a cloud architecture, in accordance with at least one non-limiting aspect of the present disclosure; and

FIG. 11 illustrates a diagram of a computing system, in accordance with at least one non-limiting aspect of the present disclosure.

Corresponding reference characters indicate corresponding items throughout the several views. The exemplifications set out herein illustrate various aspects of the present disclosure, in one form, and such exemplifications are not to be construed as limiting the scope of the present disclosure in any manner.

### DETAILED DESCRIPTION

The Applicant of the present application owns the following U.S. Provisional Patent Applications, the disclosure of each of which is herein incorporated by reference in its entirety:
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 2022;
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022
International Patent Application No. PCT/US2022/072739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022;
International Patent Application No. PCT/US2022/072743, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 3, 2022;
U.S. Provisional Patent Application No. 63/365,819 titled DEVICES, METHODS, AND SYSTEMS FOR GENERATING A HIGHLY-SCALABLE, EFFICIENT COMPOSITE RECORD INDEX, filed on Jun. 3, 2022
U.S. Provisional Patent Application No. 63/353,992 titled DEVICES, SYSTEMS, AND METHODS FOR CATEGORIZING, PRIORITIZING, AND MITIGATING CYBER SECURITY RISKS, filed on Jun. 21, 2022;
U.S. Provisional Patent Application No. 63/366,903 titled DEVICES, SYSTEMS, AND METHOD FOR GENERATING AND USING A QUERYABLE INDEX IN A CYBER DATA MODEL TO ENHANCE NETWORK SECURITY, filed on Jun. 23, 2022;
U.S. Provisional Patent Application No. 63/368,567 titled DEVICES, SYSTEMS, AND METHODS FOR UTILIZING A NETWORKED, COMPUTER-ASSISTED, THREAT HUNTING PLATFORM TO ENHANCE NETWORK SECURITY, filed on Jul. 15, 2022;
U.S. Provisional Patent Application No. 63/369,582 titled AUTONOMOUS THREAT SCORING AND SECURITY ENHANCEMENT, filed on Jul. 27, 2022;
U.S. Provisional Patent Application No. 63/377,304, titled DEVICES, SYSTEMS, AND METHODS FOR CONTINUOUSLY ENHANCING THE IMPLEMENTATION OF CODE CHANGES VIA ENRICHED PIPELINES, filed on Sep. 27, 2022;
International Patent Application No. PCT/US2022/082167 titled DEVICES, SYSTEMS, AND METHODS FOR PROVISIONING AND UPDATING SECURITY INFORMATION & EVENT MANAGEMENT ARTIFACTS FOR MULTIPLE TENANTS, filed on Dec. 21, 2022;
International Patent Application No. PCT/US2022/082173 titled DEVICES, SYSTEMS, AND METHODS FOR STREAMLINING AND STANDARDIZING THE INGEST OF SECURITY DATA ACROSS MULTIPLE TENANTS, filed on Dec. 21, 2022;
International Patent Application No. PCT/US2023/061069 titled DEVICES, SYSTEMS, AND METHODS FOR REMOTELY MANAGING ANOTHER ORGANIZATION′S SECURITY ORCHESTRATION, AUTOMATION, AND RESPONSE, filed on Jan. 23, 2023;
International Patent Application No. PCT/US2023/062894, titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 20, 2023;
International Patent Application No. PCT/US2023/021736, titled DEVICES, SYSTEMS, AND METHODS FOR SUMMARIZING ANALYTIC OBSERVATIONS, filed on May 10, 2023;
International Patent Application No. PCT/US2023/022535, titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 15, 2023; and
International Patent Application No. PCT/US2023/022858, titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 19, 2023.

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting aspects, and thus, it can be appreciated that the specific structural and functional details disclosed herein may be representative and illustrative. Variations and changes thereto may be made without departing from the scope of the claims.

Before explaining various aspects of the systems and methods disclosed herein in detail, it should be noted that the illustrative aspects are not limited in application or use to the details disclosed in the accompanying drawings and description. It shall be appreciated that the illustrative aspects may be implemented or incorporated in other aspects, variations, and modifications, and they may be practiced or carried out in various ways. Further, unless otherwise indicated, the terms and expressions employed herein have been chosen for the purpose of describing the illustrative aspects for the convenience of the reader, and they are not for the purpose of limitation thereof. For example, it shall be appreciated that any reference to a specific manufacturer, software suite, application, or development platform disclosed herein is merely intended to illustrate several of the many aspects of the present disclosure. This includes any and all references to trademarks. Accordingly, it shall be appreciated that the devices, systems, and methods disclosed herein can be implemented to enhance any software update, in accordance with any intended use and/or user preference.

As used herein, the term “server” may refer to or include one or more computing devices that are operated by or facilitate communication and processing for multiple parties in a network environment, such as the Internet or any public or private network. Reference to “a server” or “a processor,” as used herein, may refer to a previously recited server and/or processor that is recited as performing a step or function, a different server and/or processor, and/or a combination of servers and/or processors.

As used herein, the term “entity” may refer to or include a company, a business-related organization, a non-profit organization, a governmental organization, a charitable organization, an educational institution, or any other type of organization or individual that may own or have an association with a collection of cyber assets.

Reference to a “cyber asset,” as used herein, may refer to a computing device, a network, hardware, software, data, information, or any other type of information technology-related component, label, or identifier for switching, signaling, or routing, such as, for example, a domain, an Internet Protocol (IP) address, or a shared and/or dynamic asset.

As used herein, the terms “domain” and “domain name” may refer to or include a string that identifies or is otherwise associated with a network, computing device, or other resource in communication with the Internet, such as, for example, a server, personal computer, website, or other service communicated via the Internet. In some aspects, as used herein, “domain” and “domain name” may generally refer to domain names as they are described in Domain Names-Implementation and Specification, NETWORK WORKING GROUP (November 1987), the disclosure of which is incorporated by reference herein.

Entities generally have a basic need to understand and manage cyber security risks. More specifically, entities have a need to understand and manage cyber security risks related to their cyber assets. For example, an entity can have an Internet presence-a large collection of cyber assets that are used for Internet-related communications. One or more of these cyber assets may be configured such that the entity is potentially exposed to cyber security risks. Cyber security risks can include unwanted or malicious attempts to gain access to the entity's networks, data, and/or other information. Cyber security risks may also include malicious denial of usage of cyber assets by their rightful owners, for example, denial-of-service attacks or ransomware. Thus, in order to identify potential exposure to cyber security risks, and to take action against such risks, entities and/or their risk evaluators and auditors have a need to identify their cyber assets and how they are configured.

In order to further improve the management of cyber threats and other security risks, entities also have a need to identify and understand the cyber assets of other entities (sometimes referred to herein as “target entities”). This need may arise because communication between entities could lead to threat exposure or perhaps because the cyber security risks of an entity could cause a catastrophic service failure outside the realm of the Internet with adverse implications for partner entities. For example, a first entity (e.g., a “client entity”) may use its cyber assets to communicate with the cyber assets of many target entities, such as various suppliers, vendors, partners, and third parties. If the cyber assets of any of the target entities are susceptible to cyber security risks, then communicating with these assets could also put the client entity at risk. Therefore, entities have a need not only to identify and understand their own cyber assets, but also to identify and understand the risks posed by cyber assets of target entities.

However, the large-scale identification of target entities and their cyber assets can be a complex, time-consuming, and resource-intensive process. This can be particularly difficult, especially for managed security service providers (“MSSPs”) who deploy, at scale, repeatedly, and consistently, cloud-based Security Information, and Event Management (SIEM) for an extremely large number of client networks, simultaneously, as disclosed in International Patent Application No. PCT/US2022/072739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022, the disclosure of which is herein incorporated by reference in its entirety.

For example, an MSSP would have to not only manage each specific SIEM implementation for each specific client, but also each client's exposure to risks of target entities, which can result in a seemingly infinite amount network activity to continuously monitor, making it impractical for the MSSP to accomplish efficiently and reliably. Known SIEM tools lack the technological capability of scaling SIEM implementations across a large number of client networks, let alone of efficiently managing their exposure to external entities. Moreover, it can be difficult to reliably identify and distinguish target entities from one another. Further, once target entities are identified, it can be difficult to identify most or all of the thousands or even millions of cyber assets belonging to each of the target entities. The aforementioned International Patent Application No. PCT/US2023/062894, titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 20, 2023, which is herein incorporated by reference in its entirety, provides additional details related to the difficulties associated with the large-scale identification of cyber entities.

Even with a comprehensive list of target entities and their cyber assets, it can again be complex, time consuming, and resource intensive to determine which of cyber assets are susceptible to cyber security risks. For example, malicious actors are continuously attempting to identify and exploit deficiencies related to cyber assets. At the same time, cyber asset configurations can become outdated and more susceptible to attacks (e.g., because of new security protocols, software version updates, evolving industry standards related to cyber security, etc.). Thus, in order to identify these deficiencies and help protect a client entity in a meaningful way, millions of cyber assets across thousands of target entities may need to be continuously monitored for potential cyber security risks.

Moreover, simply identifying cyber security deficiencies related to the cyber assets of target entities may not be enough to meaningfully protect the client entity. The client entity will likely not be able to realize the benefits of identifying and monitoring the cyber assets of target entities unless actions are implemented to address the cyber security deficiencies that are discovered. Yet, given the magnitude and variety of cyber security risks that can exist in the cyber asset footprint of a particular target entity, it can be difficult to determine the order and urgency in which the risks need to be addressed. For example, some cyber security risks may need to be addressed immediately in order to prevent a probable attack while other risks may be less urgent or lower priority. Accordingly, there is a need for improved devices, systems, and methods for reliably identifying target entities and their cyber asset footprints, identifying cyber security risks related to the target entities' cyber assets, and organizing and reporting the identified cyber security risks so that the appropriate remediation actions can be implemented before the target entities' cyber assets are exploited.

The present disclosure presents devices, systems, and methods for identifying cyber asset footprints for a plurality of target entities, identifying cyber security risks related to the cyber asset footprints, organizing the identified risk according to a risk factor taxonomy, and reporting information related to the identified risks based on the risk factor taxonomy. These devices, systems, and methods can provide many technological benefits, such as, for example:
(a) identifying and organizing cyber security risk information related to the cyber asset footprints of target entities, in a non-routine way, by (i) monitoring a plurality of data sources comprising cyber risk information to generate source data that is organized based on risk factors, wherein the risk factors are classified according to taxonomy branches comprising IT hygiene, vulnerabilities, threats, and malicious activity; and (ii) identifying relevant observations in the source data by correlating the cyber risk information to the cyber asset footprints of the target entities;
(b) issuing findings related to the identified cyber security risk information and transmitting alerts and/or reports based on the taxonomy branch of the risk factor associated with the finding-thereby providing a specific improvement over prior cyber security risk management systems and integrating the organization of cyber risk information according to risk factors and taxonomy branches into a practical application; and
(c) managing cyber security risk for a client entity communicating with a plurality of target entities at a scale not practically performed by the human mind by (i) identifying cyber asset footprints for the target entities, (ii) monitoring a plurality of data sources comprising cyber security risk information to generate source data, and (iii) identifying relevant observations in the source data by correlating cyber security risk information in the source data to one of the cyber asset footprints.

Furthermore, the devices, systems, and methods described here can provide technological benefits by initiating remediation actions based on the taxonomy branch associated with the issued finding—thereby providing a specific improvement over prior cyber security risk management systems and integrating the organization of cyber risk information according to risk factors and taxonomy branches into a practical application.

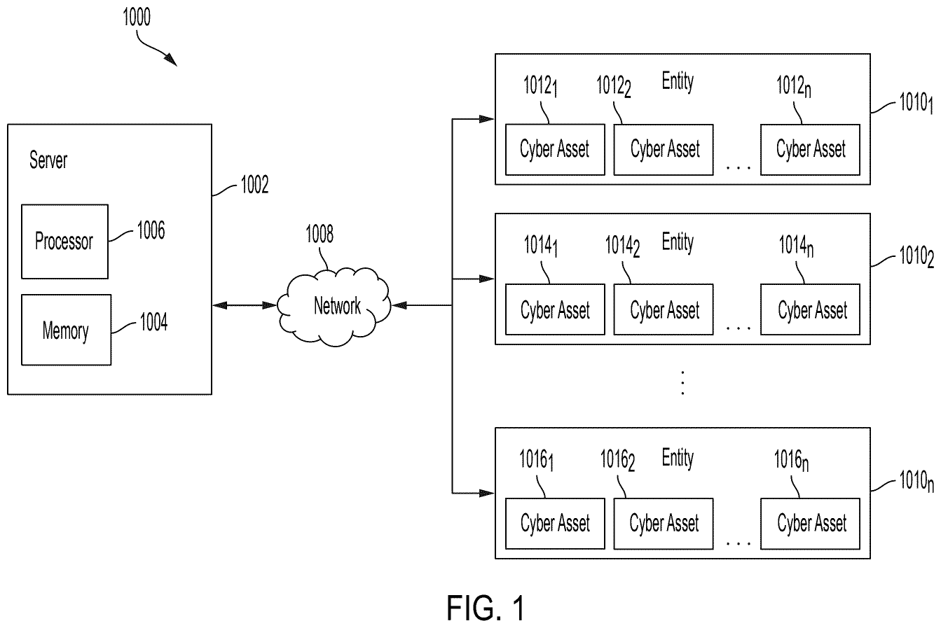

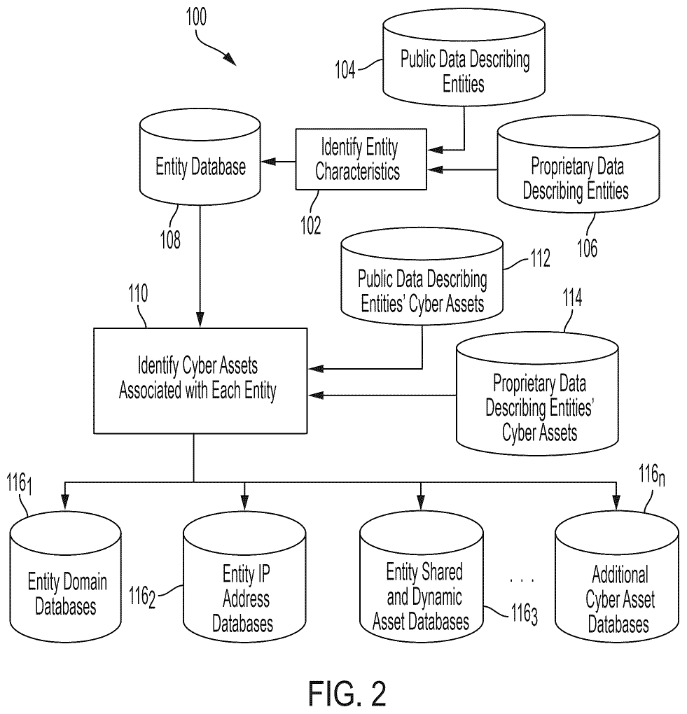

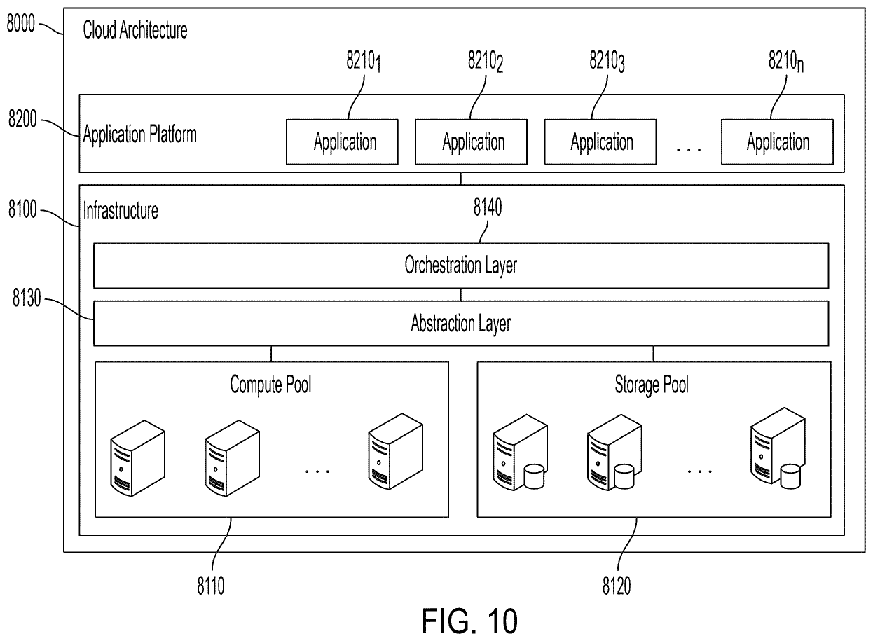

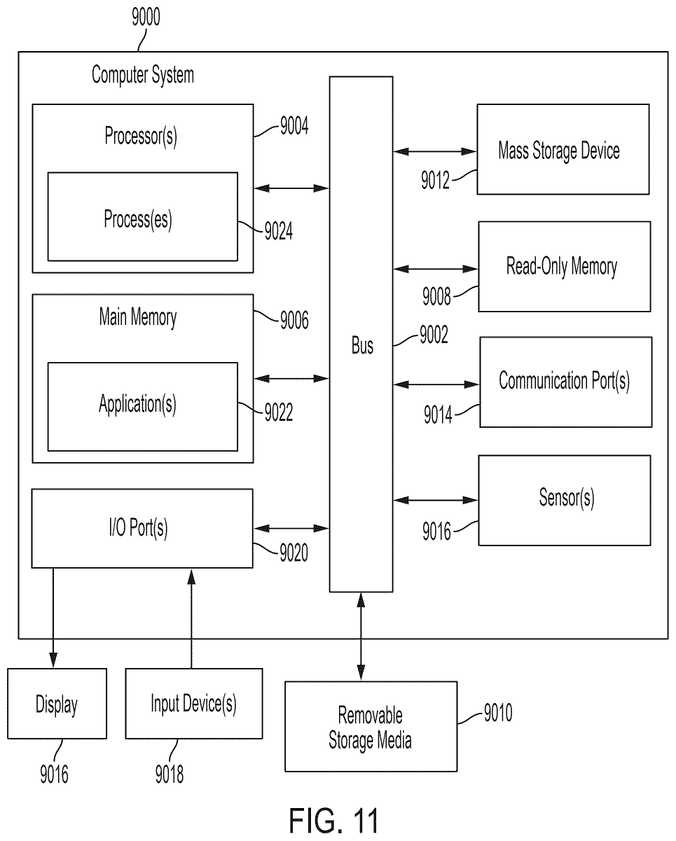

Referring now to FIG. 1, a diagram of a system 1000 configured for identifying cyber assets and generating cyber risk mitigation actions for a plurality of entities is illustrated, in accordance with at least one non-limiting aspect of the present disclosure. The system 1000 can include a cyber security risk management provider server 1002 comprising a memory 1004 and a processor 1006. As mentioned above, server 1002 can refer to or include one or more computing devices that are operated by or facilitate communication and processing for multiple parties in a network environment. For example, cyber security risk management provider server 1002 can be implemented according to cloud architecture 8000, as will be discussed further in reference to FIG. 10. In various aspects, cyber security risk management provider server 1002 can comprise the computer system 9000 and the various components thereof, as will be discussed further in reference to FIG. 11. The memory 1004 may be configured to store instructions that, when executed by the processor 1006, carry out various aspects of the processes 100, 200, and/or 300 as described below with respect to FIGS. 2-3 and 5-9.

The cyber security risk management provider server 1002 can be communicably coupled, via network 1008, to a plurality of entities 1010₁, 1010₂ . . . 1010ₙ. Each entity 1010₁, 1010₂ . . . 1010ₙ of the plurality can represent a tenant (e.g., a client entity) contracting with the cyber security risk management provider for cyber security services and/or an entity that may be evaluated by the cyber security risk management provider for cyber security-related deficiencies (e.g., a target entity). According to a non-limiting aspect of FIG. 1, the network 1008 can include any variety of wired (e.g., fiber optic cabling), long-range wireless, and/or short-range wireless networks. For example, the network 1008 can include an internal network, a Local Area Network (LAN), Wi-Fi, cellular networks, or near-field communication, among others.

In further reference to FIG. 1, each entity 1010₁, 1010₂ . . . 1010ₙ, of the plurality can host and/or be associated with one or more instances of one or more cyber assets 1012, 1014, 1016. For example, a first entity 10101 can include one or more machines implementing or otherwise associated with one or more cyber assets 1012₁, 1012₂ . . . 1012ₙ, a second entity tenant 10102 can include one or more machines implementing or otherwise associated with one or more cyber assets 1014₁, 1014₂ . . . 1014ₙ, and/or a third entity 1010ₙ can include one or more machines implementing or otherwise associated with one or more cyber assets 1016₁, 1016₂ . . . 1016ₙ. Each entity 1010₁, 1010₂, . . . 1010ₙ can include an intranet (i.e., network) by which each machine can communicate. As mentioned above, any of the entities 1010₁, 1010₂, . . . 1010ₙ can represent a tenant (e.g., a client entity), such as an organization, contracting with the cyber security risk management provider for security management services. Accordingly, the cyber security risk management provider server 1002 can be configured to have oversight over one or more of the entities 1010₁, 1010₂, and 1010ₙ of the plurality and, thus, can be responsible for monitoring and/or managing an entity's cyber assets (e.g., 1012, 1014, 1016) in order to mitigate cyber security threats.

However, as previously discussed, identifying the cyber assets (e.g., 1012, 1014, 1016) of a plurality of entities (e.g., 1010₁, 1010₂, . . . 1010ₙ) and identifying which cyber assets (e.g., 1012, 1014, 1016) are susceptible to cyber security risks can be a complex and resource-intensive process. Moreover, entities (e.g., 1010₁, 1010₂, . . . 1010ₙ) will likely be unable to realize the benefits of identifying which of the cyber assets are susceptible to cyber security risks unless actions are implemented to address the cyber security deficiencies that are discovered. Thus, the disclosure now turns to various methods for identifying the cyber assets of a plurality of entities and generating cyber security risk mitigation actions based on the identified assets.

Referring now to FIG. 2, a flow chart of a process 100 for identifying cyber assets associated with a plurality of entities is illustrated, in accordance with at least one non-limiting aspect of the present disclosure. The process 100 of identifying cyber assets associated with a plurality of entities is sometimes referred to herein as “the footprinting process 100.” In various aspects, any of the steps of footprinting process 100 can be executed using an algorithm that employs machine learning, statistical techniques, and/or logical and expert systems-based techniques, as well as searching, sorting, collation, and other data-processing techniques and logic.

The footprinting process 100 can proceed by identifying 102 target entity-specific characteristics to generate entity database 108. It may be difficult to distinguish between entities because of ambiguities related to their identifying characteristics (e.g., entities may do business under the same or similar names). Thus, identifying 102 entity-specific characteristics can comprise executing an algorithm that causes the search and analysis of public data describing entities 104 and/or proprietary data describing entities 106 for identifiers that are specifically unique to a particular entity. Those unique identifiers can be correlated to specific entities to generate an entity database 108. For example, searching public and/or proprietary data describing entities 104, 106 (e.g., domain registration data) may reveal that the domain “islandrealty.com” is registered to an organization doing business under the name “Island Realty” in South Carolina. Thus, because the domain “islandrealty.com” is unique and may not be shared by other entities doing business under the name “Island Realty” in other locations, it can be used to reliably distinguish the cyber presence and at least some of the assets of the “Island Realty” in South Carolina from other entities. This domain can be correlated with Island Realty in South Carolina and added to entity database 108.

The identifiers used to generate the entity database 108 can comprise identifiers such as, for example, Internet domains, street addresses, phone numbers, corporate registration numbers, and tax identifiers. The public data describing entities 104 can comprise databases with information such as, for example, Security and Exchange Commission (SEC) filings, Internal Revenue Service (IRS) disclosures, state-based corporate and/or charitable registrations with Secretaries of State, legal filings, government filings, Global Legal Entity Identifier Foundation identifiers, Public Key Certificates, information found on organizational websites, public Internet registrations, patent filings, and trademark filings. The proprietary data describing entities 106 can comprise databases with information such as, for example, catalogs of firmographic information concerning entities purchased from Dun & Bradstreet, Moody's, Standard & Poor's, ZoomInfo, Open Corporates, and mailing lists and/or sales lead suppliers. The public data describing entities 104 and proprietary data describing entities 106 can often be incomplete and contain errors. Accordingly, in various aspects, identifying 102 entity-specific characteristics can comprise employing machine learning and/or statistical techniques, searching, sorting, collating, and logic-driven discrimination, such as expert systems evaluation, to disambiguate entities.

The footprinting process 100 can continue by identifying 110 cyber assets associated with the target entities in entity database 108. As explained above, a given entity can be associated with several different types of cyber assets, such as, for example, domains, IP addresses, and shared and dynamic assets. However, no prior source or method exists from which cyber assets of multiple entities can be easily identified and classified. Thus, to address this need, identifying 110 cyber assets associated with the entities in entity database 108 can comprise executing an algorithm or algorithms that cause the search and analysis of public data describing entities' cyber assets 112 and/or proprietary data describing entities' cyber assets 114. Based on this search and analysis, the specific types of cyber assets can be identified and correlated with the identifiers stored in entity database 108 to generate entity domain databases 1161, entity IP address databases 1162, entity shared and dynamic asset databases 1163, and/or any number of other cyber asset databases 116, for storing data related to various types of cyber assets (collectively the “cyber asset databases 116”). In various aspects, the algorithm or algorithms used for identifying 110 cyber assets can employ searching, sorting, collating, and/or statistical techniques; logic-driven discrimination, such as with an expert system evaluation; and/or machine learning.

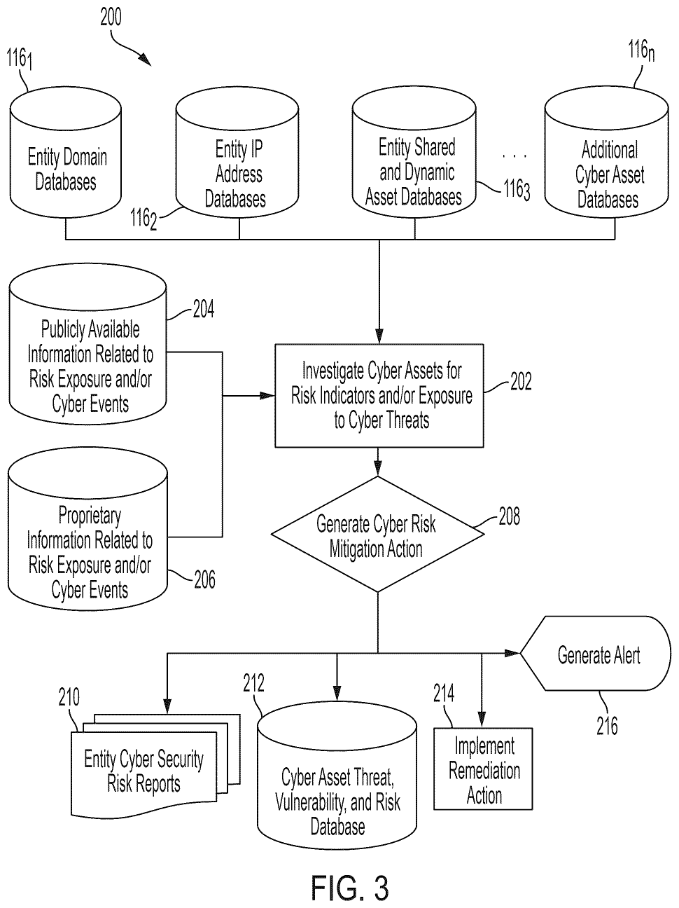

In one aspect, the entity domain databases 1161 can comprise a plurality of domain databases, wherein each domain database comprises domains that have been classified as being associated with a particular entity from the entity database 108. In another aspect, the entity IP address databases 1162 can comprise a plurality of IP address databases, wherein each IP address database comprises IP addresses that have been classified as being associated with a particular entity from entity database 108. In another aspect, the entity shared and dynamic asset databases 1163 can comprise a plurality of shared and dynamic asset databases, wherein each shared and dynamic asset database comprises shared and dynamic assets that have been classified as being associated with a particular entity from entity database 108. In yet another aspect, various other types of other cyber asset databases 116, can each comprise a plurality of type-specific cyber asset databases, wherein each type-specific cyber asset database comprises a specific type of cyber assets that have been classified as being associated with a particular entity from entity database 108. The cyber asset databases 116 can be used as the basis for generating cyber risk mitigation actions, as discussed below with respect to FIG. 3.

Referring now to FIG. 3, a flow chart of a process 200 for generating cyber security risk mitigation actions across a plurality of entities, based on cyber asset databases 116 is illustrated, in accordance with at least one non-limiting aspect of the present disclosure. The process 200 of generating cyber security risk mitigation actions across a plurality of entities is sometimes referred to herein as “the cyber risk mitigation process 200.” In various aspects, any of the steps of the cyber risk mitigation process 200 can be executed using an algorithm that employs searching, sorting, collating, and/or statistical techniques; logic-driven discrimination, such as with an expert system evaluation; and/or machine learning.

The cyber risk mitigation process 200 can begin by investigating 202 cyber assets of one or more of the cyber asset databases 116 for risk indicators and/or exposure to cyber threats. As explained above, any of the cyber assets (e.g., domains, IP addresses, and shared and dynamic assets) of an entity may be configured such that the entity is exposed to cyber security risks. Thus, investigating 202 the cyber asset databases 116 can comprise executing an algorithm or algorithms to determine which of the various cyber assets in cyber asset databases 116 may comprise a configuration that is vulnerable to or being exploited by a cyber threat.

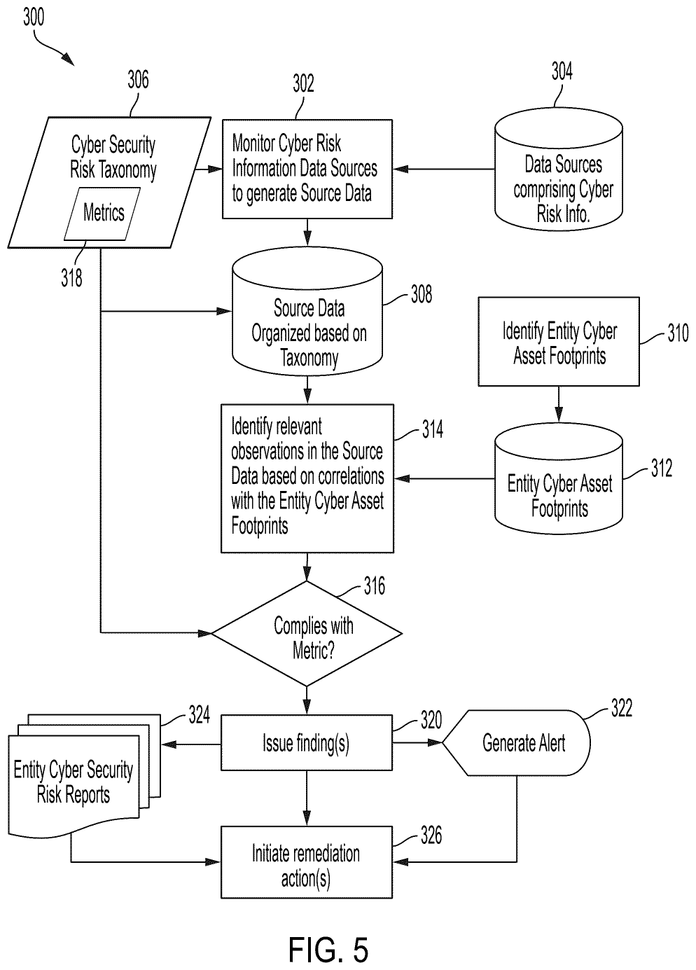

Still referring to FIG. 3, in various aspects, the risk indicators and threat exposure related to given cyber asset configuration may be time-dependent and/or may vary depending on the occurrence of various cyber events. Thus, investigating 202 cyber asset databases 116 for risk indicators and/or exposure to cyber threats can also comprise searching and analyzing the Internet for publicly available information 204 related to the presence of exploitation risk or the occurrence of cyber events and/or searching and analyzing the Internet for proprietary information 206 related to the presence of exploitation risk or the occurrence of cyber events. In various aspects, investigating 202 the cyber asset databases 116, publicly available information 204, and/or proprietary information 206 for risk indicators and/or exposure to cyber threats may comprise one or more of the steps of the process 300 for managing cyber risk based on a risk factor taxonomy described in detail below with respect to FIGS. 5-9.

Still referring to FIG. 3, the cyber security risk mitigation process 200 can continue by generating 208 one or more cyber security risk mitigation actions based on the cyber threats and risk indicators identified at 202. Generating 208 a cyber security risk mitigation action can comprise, for example, generating entity cyber security risk reports 210, generating a cyber asset threat, vulnerability, and risk database 212, implementing 214 a remediation action, and generating 216 an alert.

In various aspects, generating 208 a cyber security risk mitigation action can comprise generating entity cyber security risk reports 210. The entity cyber security risk reports 210 can comprise one or more reports, each report comprising an evaluation of the cyber threat exposure of one or more entities in entity database 108 (FIG. 2) based on the investigation performed at 202. The entity cyber security risk reports 210 can comprise a risk level score and/or other type of risk assessment that can be used by the cyber risk management provider to determine the relative risk level of a particular entity compared to other entities in entity database 108. In some aspects, the entity cyber security risk reports 210 can be similar to entity cyber security risk reports 324 discussed below with reference to FIG. 5.

In various aspects, generating 208 a cyber security risk mitigation action can comprise generating an entity's cyber asset threat, vulnerability, and risk database 212. The cyber asset threat, vulnerability, and risk database 212 can comprise a log of each of the assets from cyber asset databases 116 that has been identified as being exposed to a cyber threat, vulnerability, and/or risk at 202. The cyber asset threat, vulnerability, and risk database 212 or portions thereof may be referenced by the cyber risk management provider when making asset management decisions. For example, the cyber asset threat, vulnerability, and risk database 212 can be used to identify cyber assets that need configuration updates.

In various aspects, generating 208 a cyber risk mitigation action can comprise implementing 214 a remediation action. In some aspects, implementing 214 a remediation action can comprise executing an algorithm that causes an automated configuration update to one or more of the cyber assets identified as exposed to a cyber threat at 202. In some aspects, implementing 214 a remediation action can be similar and/or include initiating 326 remediation action(s) discussed below with reference to FIG. 5.

In various aspects, generating 208 a cyber risk mitigation action can comprise generating 216 an alert in response to identifying risk indicators and/or threat exposure related to one or more cyber assets at 202. For example, in one aspect, an alert may be sent to a security analyst of the cyber risk management provider and/or other parties charged with managing the cyber security of a particular entity. In other aspects, an alert may be sent to an entity, a cyber asset, and/or to the user of a cyber asset associated with an identified cyber threat. The generated 216 alert can comprise instructions for the security analyst, user, or other party to take a specific action in response to an identified cyber threat. In another aspect, the alert can also take the form of an automated control instruction to computer systems providing security services, for example a control message for closing a port could be sent to an entity's firewall upon seeing evidence of malicious activity. In some aspects, generating 216 an alert can be similar and/or include generating 322 an alert as discussed below with reference to FIG. 5.

### Categorizing, Prioritizing, and Mitigating Cyber Security Risks

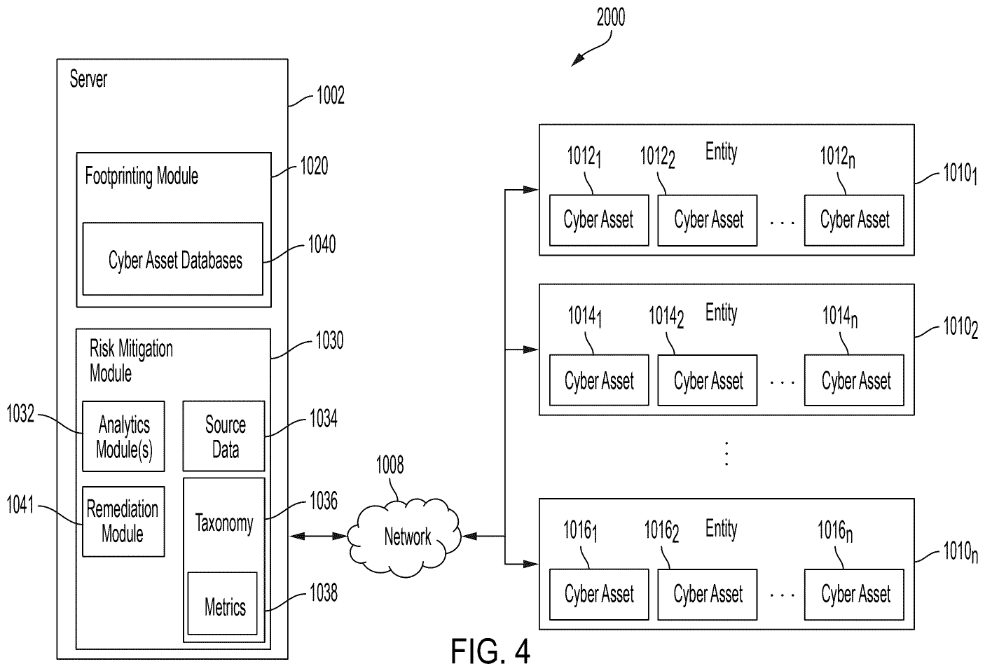

Having described a general implementation of devices, systems, and methods for identifying entities with an Internet presence, identifying of cyber assets associated with the target entities, and generating cyber security risk mitigation actions based on the identified cyber assets, the disclosure now turns to the specific implementation of these devices, systems, and methods as they relate to managing cyber security risk based on a cyber security risk taxonomy. Any of the aspects described below with respect to FIGS. 4-9 can be applied to the devices, systems, and methods described above with respect to the system 1000 of FIG. 1, the footprinting process 100 of FIG. 2, and the cyber risk mitigation process 200 of FIG. 3.

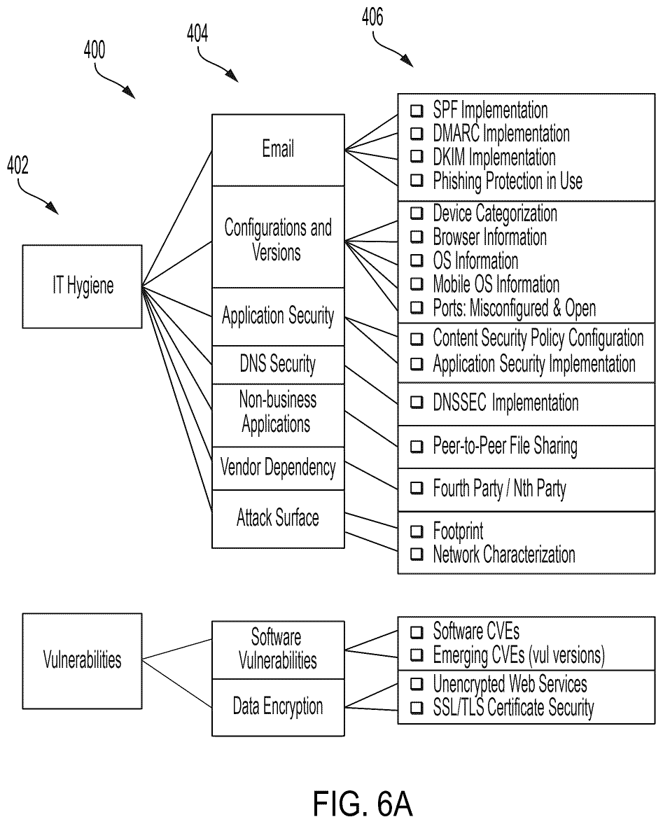

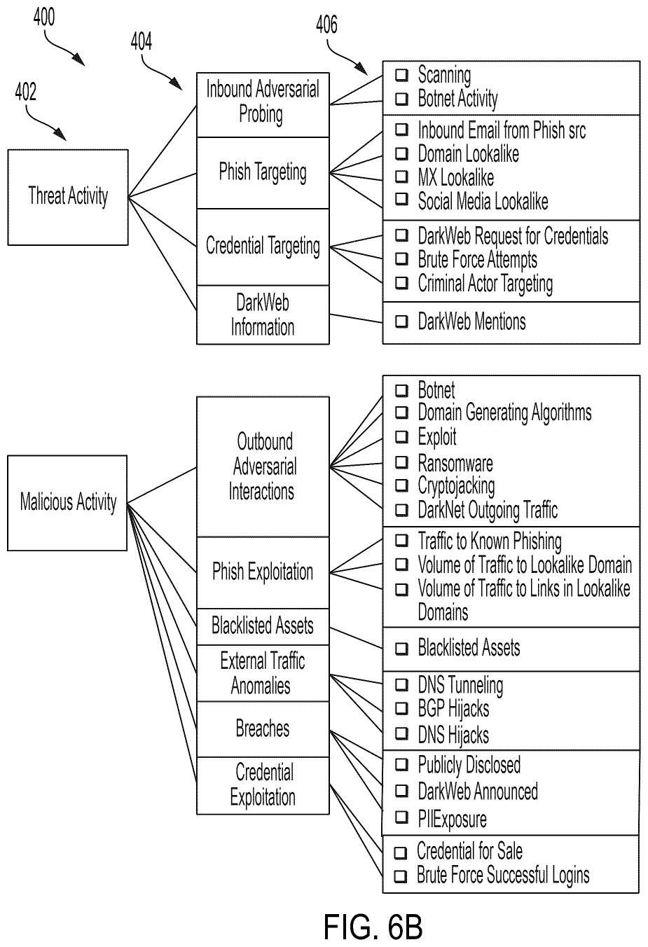

FIG. 4 illustrates a diagram of a system 2000 configured for identifying cyber assets and generating cyber risk mitigation actions for a plurality of entities based on a cyber security risk taxonomy, in accordance with at least one non-limiting aspect of the present disclosure. FIG. 5 illustrates a flow chart of a process 300 for managing cyber risk based on a cyber security risk taxonomy, and FIGS. 6A-6B illustrate an example of a cyber security risk taxonomy 400 that can be employed by the process 300, in accordance with several non-limiting aspects of the present disclosure. The process 300 of FIG. 5 may be executed by the system 2000 of FIG. 4.

Referring now to FIG. 5, the process 300 can begin by monitoring 302 data sources 304 comprising cyber security risk information to generate organized source data 308. The data sources 304 can include a plurality of different publicly available and/or proprietary data sources comprising information related to cyber security risks. For example, the data sources 304 can include the publicly available information 204 related to risk exposure and/or cyber events and/or the proprietary information 206 related to risk exposure and/or cyber events described above with respect to FIG. 3. The following paragraphs provide various non-limiting examples of the types of information related to cyber risks that can be monitored 302 in the data sources 304. Further, the cyber security risk taxonomy 400 discussed below in reference to FIGS. 6A-6B can provide a fuller appreciation of the various data sources 304 that may be monitored 302.

In one aspect, monitoring 302 data sources 304 can include scanning internet protocol (IP) addresses for information related to services, security certificates, and/or configurations associated with various cyber assets. The information obtained from scanning an IP address may be used to determine the exposure level of these cyber assets to various cyber threats.

In one aspect, monitoring 302 data sources 304 can include monitoring security certificate repositories. The information obtained from monitoring security certificate repositories can be used to identify vulnerabilities related to certificate-based attack techniques.

In one aspect, monitoring 302 data sources 304 can include monitoring/collecting domain name system (DNS) records for various domains. For example, monitoring 302 data sources 304 can include monitoring the DNS records (e.g., including mail exchange (MX) records) for domains identified 310 in target entity cyber asset footprints 312, as discussed in more detail below. The monitored DNS records can be used to discover cyber risk-related information by identifying technology vendors (e.g., supporting fourth-party analytics), security technologies (e.g., email scanners, multi-factor identify usage), IP ranges, extended network infrastructure, and/or security configurations (e.g., email DNS protections) that may be used to assess a target an entity's protection against and/or exposure to cyber security risks.

In one aspect, monitoring 302 data sources 304 can include monitoring passive DNS transactions. The monitored information related to DNS transactions can be used, for example, to discern cyber risk-related information such as extended network infrastructure (e.g., cloud/hosted assets) related to cyber assets and target entities, inbound scanning activity related to cyber assets indicative of threat actor interest, outbound connections of cyber assets to malicious infrastructure indicative of active malware and/or hacking activity in a target entity's infrastructure, use of dangerous applications (e.g., Tor software), and clicks on links to phishing actor websites.

In one aspect, monitoring 302 data sources 304 can include monitoring Dark Net and/or Dark Web sites. The monitored information related to Dark Net/Dark Web sites can be used to identify breaches, threats, attack modalities, exposed credentials, other personally identifiable information (PII), and zero-day attacks (e.g., newly emerging vulnerabilities).

Referring still to FIG. 5, the organized source data 308 generated by monitoring 302 data sources 304 comprising cyber risk information can be organized based on a cyber security risk taxonomy 306. The cyber security risk taxonomy 306 is an organizational structure used to classify and evaluate various cyber risk-related information. At the lowest level, the cyber security risk taxonomy 306 classifies cyber risk-related information according to risk factors. As discussed in more detail below, information related to a particular risk factor can be analyzed according to one or more metrics 318 to assist in the evaluation of a target entity's cyber security risk. At the next higher level, each of the risk factors in the cyber security risk taxonomy 306 is classified according to a risk category. The risk categories can be used to group risk factors based on the type of cyber risk that each risk factor captures. At the highest level, each of the risk categories in the cyber security risk taxonomy 306 are classified according to a taxonomy branch. FIGS. 6A-6B illustrate an example of a cyber security risk taxonomy 400 that can be employed as cyber security risk taxonomy 306 of process 300.

Referring now to FIGS. 6A-6B, the cyber security risk taxonomy 400 can include taxonomy branches 402, risk categories 404, and risk factors 406. According to the non-limiting aspect of FIGS. 6A-6B, the taxonomy branches 402 can include information technology (IT) hygiene, vulnerabilities, threats, and malicious activity. In other aspects, taxonomy branches may include email, IT hygiene, vulnerabilities, threats, and malicious activity.

Risk categories 404 and risk factors 406 classified in the IT hygiene taxonomy branch 402 are related to the decisions a target entity makes about how it builds and manages its IT. For example, risk categories 404 classified in the IT hygiene taxonomy branch 402 can include email security, configuration information (e.g., patching levels, versioning), application security (e.g., security built into Internet-facing applications), DNS security (e.g., security related to preventing manipulation or poisoning of responses to DNS requests by authenticating responses), non-business applications (e.g., such as the use of Tor, social media, and other applications that induce risk), vendor dependency (e.g., emphasis on technology, vendor discovery, and analysis), and attack surface-related vulnerabilities (e.g., vulnerabilities related to a target entity's domains/IPs and hosting strategies). As discussed in more detail below, information related to risk factors 406 in the IT hygiene taxonomy branch 402 can be compared to industry best practices to determine the actual state of a target entity's IT infrastructure as it relates to cyber security.

Risk factors 406 in the email security category 404 can include risk factors related to sender policy framework (SPF) implementation, domain-based message authentication reporting and conformance (DMARC) implementation, domain key identified mail (DKIM) implementation, secure hosting of email, and/or phishing protection implementation.

Risk factors 406 in the configurations and versions category 404 can include device categorization, browser information, operating system (OS) information, mobile OS information, and/or ports (e.g., ports that are misconfigured and/or open).

Risk factors 406 in the application security category 404 can include risk factors related to content security policy configuration and/or application security implementation.

Risk factors 406 in the DNS security category 404 can include risk factors related to domain name system security extension (DNSSEC) implementation.

Risk factors 406 in the non-business applications risk category 404 can include risk factors related to peer-to-peer file sharing.

Risk factors 406 in the vendor dependency risk category 404 can include risk factors related to fourth-party (and/or fifth party through Nth party) discovery and analysis and/or vendor dependency layering.

Risk factors 406 in the attack surface category 404 can include risk factors related to a target entity's cyber asset footprint and/or network characterization.

Risk categories 404 and risk factors 406 classified in the vulnerabilities taxonomy branch 402 are related to various combinations of software, hardware, and configurations that are vulnerable to cyber attacks. Thus, the vulnerabilities taxonomy branch 402 can relate to various scanning-and transaction-based information that may be analyzed to identify active vulnerabilities in a target entity's IT. For example, risk categories 404 classified in the vulnerabilities branch 402 can include software vulnerabilities (e.g., known vulnerabilities based on software versions) and data encryption (e.g., data-in-motion protection). As discussed in more detail below, information related to risk factors 406 in the vulnerabilities taxonomy branch can be used as the basis for notifying a client entity and/or a target entity of active vulnerabilities in the target entity's infrastructure so those vulnerabilities can be remediated before they are exploited.

Risk factors 406 in the software vulnerabilities category 404 can include software common vulnerabilities and exposures (CVEs) and/or emerging CVEs. Software CVEs and/or emerging CVEs, for example, may refer to CVEs in the CVE database maintained by The MITRE Corporation.

Risk factors 406 in the data encryption category 404 can include risk factors related to unencrypted web services and/or SSL/TLS certificate security.

Risk categories 404 and risk factors 406 classified in the threat activity taxonomy branch 402 are related to potential threats posed by various cyber criminals and other malicious actors. These cyber criminals and malicious actors typically work to capture information about cyber security vulnerabilities of entities that are of interest to them in order to exploit these entities. For example, cyber criminals may scan infrastructure, search Dark Web sites for credentials, create attack code to leverage emerging vulnerabilities, send phishing emails to users seeking to deploy malware or to capture more information, and collaborate with other criminal groups to share information. Each group of cyber criminals can employ unique methods of working and attacking (e.g., Tactics, Techniques and Procedures (TTPs)) and can be focused on various interests and goals. Thus, the threat activity taxonomy branch 402 can include information related to tracking the activity and/or the personality of these various cyber criminals and malicious actors to understand the level of threat to a given target entity. Accordingly, the risk categories 404 classified in the threats branch 402 can include information related to inbound adversarial probing (e.g., traffic from a known malicious actor infrastructure to a target entity), phish targeting (e.g., traffic from a known phishing infrastructure to a target entity), credential targeting, and/or Dark Web information (e.g., traffic on Dark Web sites indicating interest in a target entity). As discussed in more detail below, information related to risk factors 406 in the threat activity taxonomy branch can be used as the basis for notifying a client entity and/or a target entity of potential threats to a target entity based on the activity and/or personality of various cyber criminals and malicious actors.

Risk factors 406 in the inbound adversarial probing category 404 can include risk factors related to scanning and/or botnet activity.

Risk factors 406 in the phish targeting category 404 can include risk factors related to inbound emails from phishing sources, domain lookalikes, mail exchange (MX) lookalikes, and/or social media lookalikes.

Risk factors 406 in the credential targeting category 404 can include risk factors related to DarkWeb requests for credentials, brute force attempts, and/or criminal actor targeting.

Risk factors 406 in the Dark Web information category 404 can include risk factors related to Dark Web mentions (e.g., of a target entity) by various cyber criminals or other malicious actors.

Risk categories 404 and risk factors 406 classified in the malicious activity taxonomy branch 402 are related to various indicators that suggest a target entity has been successfully attacked. These indicators may be found across the Internet and the Dark Web. For example, malware reaching out from within a target entity's infrastructure to destinations known to be malicious may be indicative of a successful attack. As another example, clicks on phishing email links may be indicative of a successful attack. As yet another example, discovering credentials for sale on the Dark Web may be indicative of a successful attack. Accordingly, the risk categories 404 classified in the malicious activity branch 402 can include outbound adversarial interactions (e.g., traffic from a target entity to a known malicious infrastructure), phish exploitation (e.g., traffic from a target entity to a known phishing infrastructure), blacklisted assets, external traffic anomalies (e.g., indicators of foul play for routing), breaches (e.g., information related to breaches of a target entity), and credential exploitation (e.g., information suggesting credentials related to a target entity have been obtained and/or are being used). As discussed in more detail below, information related to risk factors 406 in the malicious activity taxonomy branch 402 can be used as the basis for alerting a client entity and/or a target entity of a successful breach.

Returning to FIG. 5, the process 300 can also include identifying 310 entity cyber asset footprints 312. The entity cyber asset footprints 312 can include a plurality of different cyber asset footprints, wherein each cyber asset footprint comprises cyber assets associated with (e.g., owned or otherwise controlled by) a different target entity. For example, the entity cyber asset footprints 312 may be similar to the entity cyber asset databases 116 generated by the footprinting process 100 described above with respect to FIG. 2. Thus, identifying 310 entity cyber asset footprints 312 can include one or more of the steps of the footprinting process 100 described above. In some aspects, identifying 310 entity cyber asset footprints can include employing the various systems and methods described in the aforementioned International Patent Application No. PCT/US2023/062894, titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 20, 2023 and/or the aforementioned International Patent Application No. PCT/US2023/022535, titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 15, 2023.

Still referring to FIG. 5, the process 300 can continue by identifying 314 relevant observations in the organized source data 308 by correlating information in the source data 308 to cyber assets in the entity cyber asset footprints 312. The relevant observations are information from the source data 308 that apply to or are otherwise related to one or more of the cyber assets of one or more of the target entities. Thus, identifying 314 relevant observations in the organized source data 308 correlates the information describing the various risk factors to the target entities.

The process 300 can further include determining 316 whether or not the relevant observations comply with one or more predetermined metrics 318. Each of the predetermined metrics 318 is related to a specific risk factor from the cyber security risk taxonomy 306 and can be used to evaluate information related to that risk factor. As mentioned above, each relevant observation includes information related to one of the risk factors that correlates to at least one of the target entities. Thus, a cyber risk assessment for a plurality of target entities can be executed by analyzing each relevant observation according to one or more predetermined metrics 318. In some aspects, findings can be issued 320 based on determining 312 that the relevant observation does not comply with one or more predetermined metrics 318. In other aspects, findings can be issued 320 based on determining that the relevant observation does comply with one or more predetermined metrics 318.

For example, one of the risk factors from the cyber security risk taxonomy 306 may be an email security sender policy framework (SPF) risk factor classified under the IT hygiene taxonomy branch. According to the process 300, monitoring 302 data sources 304 can include monitoring various DNS records and MX records. These records may indicate the use of a particular mail server. The SPF record for this particular mail server can be retrieved, and thus, monitoring 302 data sources 304 can result in the generation of organized source data 308 that includes the SPF record (which is organized according to the cyber security risk taxonomy 306 as information related to the email security SPF risk factor). This information may be identified 314 as a relevant observation by correlating the use of the mail server (e.g., via the MX records) to cyber assets in the entity cyber asset footprints 312, thereby correlating the SPF record to a particular target entity. Metrics 318 for the email security SPF risk factor may be defined to evaluate email-related aspects of the target entity's IT hygiene. As one example, metrics 318 for the email security SPF risk factor can include a metric to determine whether or not an SPF is present (e.g., a binary “present” metric). Based on the presence of the SPF record in the source data 308, it can be determined 316 that, in this instance, the target entity is in compliance with the “present” email security SPF metric 318. On the other hand, if no relevant observation is identified 314 because no SPF record was found for the mail server correlated with a particular target entity's cyber assets, then the “present” email security SPF metric 318 would be violated for the target entity. This process 300 of identifying 314 relevant observations and determining 316 if the relevant observations comply with predetermined metrics 318 can be carried out for many observations related to various risk factors across the cyber security risk taxonomy 306. Thus, evaluating relevant observations within the framework of the cyber security risk taxonomy 306 can ultimately enable an organized and targeted assessment of the cyber risks that various target entities pose to a client entity.

Still referring to FIG. 5, the process 300 can continue by issuing 320 one or more findings based on determining 316 whether or not a relevant observation complies with one or more of the predetermined metrics 318. As discussed in detail below, the issued 320 findings can be used to: generate 322 alerts that are transmitted to a client entity and/or target entities, generate entity cyber security risk reports 324 that can be used to help a client entity evaluate the target entities, and/or initiate 326 remediation actions(s) for the client entity and/or target entities.

Each issued 320 finding may include a criticality level (e.g., low, medium, high, urgent, act now, etc.). The criticality level assigned to each finding can be based on the urgency with which the finding should be addressed and/or based on the severity of the finding. Thus, the criticality level can be used to determine the type of alert that should be generated 322 and/or the type of remediation action that should be initiated 326 in response to an issued 320 finding. Furthermore, the cyber security risk taxonomy 306 can be used to help determine the criticality level of a finding.

For example, findings related to IT hygiene risk factors may include a lower level of criticality compared to risk factors under other taxonomy branches. In some aspects, this is because the IT hygiene taxonomy branch generally relates to the decisions a target entity makes about how it builds and manages its IT. The various risk factors and associated metrics 318 can be used to evaluate a target entity's IT hygiene in a non-subjective manner (e.g., industry best practices are defined by organizations such as the National Institute of Standards and Technology (NIST), the Center for Internet Security (CIS), and the SANS Institute, etc.). Thus, generally, there are well-defined actions that a target entity can implement to remediate findings issued 320 related to IT hygiene risk factors. However, the urgency with which these actions need to be implemented is generally lower than the urgency with which remediation actions need to be implemented for findings based on other taxonomy branches.

As another example, findings related to vulnerability risk factors may include a higher criticality level (e.g., a criticality level associated with a higher sense of urgency) compared to risk factors under other taxonomy branches. In some aspects, this is because the vulnerabilities taxonomy branch generally relates to various combinations of software, hardware, and configurations that are known to be vulnerable to cyber attacks. Thus, when it is discovered that a specific software, hardware, or configuration is susceptible to attack, it may be important to remediate the deficiency (e.g., by upgrading the application to a patched version, by removing the application, etc.) as quickly as possible in order to prevent exploitation.

As yet another example, findings related to threat activity risk factors may include a lower criticality level compared to risk factors under other taxonomy branches. In some aspects, this is because the threat activity taxonomy branch generally relates to potential threats posed by various cyber criminals and other malicious actors. These threats can be identified based on monitoring the activity of cyber criminals and other malicious actors to determine their interests (and therefore potential targets). For example, a finding may include information indicating that a SPAM or phishing purveyor is sending targeted emails to a target entity. As another example, a finding may include information indicating that a known ransomware actor is scanning the infrastructure of a target entity. By combining the typical attack modality of the bad actor (e.g., ransomware, phishing, etc.) with the bad actor's volume of activity, the bad actor's level of interest in a target entity may be determined. Thus, somewhat unlike the IT hygiene branch, well-defined actions may not be available for a target entity to implement to remediate findings issued 320 related to threat activity risk factors. Moreover, if it is determined that a target entity has relatively good IT hygiene, then findings related to threat activity risk factors may include the lowest criticality level compared to risk factors under other taxonomy branches.

As yet another example, findings related to malicious activity may include a higher (or even the highest) criticality level compared to risk factors under other taxonomy branches. In some aspects, this is because the malicious activity taxonomy branch generally relates to various indicators that suggest a target entity has been successfully attacked. For example, findings related to the malicious activity taxonomy branch may indicate that a user of a target entity clicked on a link in a phishing email or that malware (e.g., including ransomware) has been installed somewhere within the target entity's enterprise. Findings of active malicious activity (e.g., as opposed to more stale attacks, such as observing credentials for sale on a Dark Web site) may include the highest criticality level compared to risk factors under other taxonomy branches.

Referring still to FIG. 5, the process 300 can continue by generating 322 an alert based on the issued 320 findings. Generating 322 an alert can include transmitting an alert to a client entity and/or transmitting an alert to a target entity in response to an issued 320 finding. In some aspects, generating 322 an alert can transmitting an alert to cyber asset, and/or to the user of a cyber asset associated with the finding. In some aspects, the alert can be generated 322 based on the criticality level of the finding. Thus, in some aspects, the alert may be generated 322 based on the taxonomy branch of the risk factor associated with the finding.

For example, an alert generated 322 in response to an IT hygiene risk factor finding for a particular target entity may be transmitted to a client entity and/or the target entity including information related to an aspect of the target entity's IT that should be addressed/remediated.

As another example, an alert generated 322 in response to a vulnerability risk factor finding for a particular target entity may be transmitted to a client entity and/or the target entity including instructions to take immediate remediation action in response to the finding. The alert to the target entity may include information related to the detected vulnerability and instructions for how to remediate the vulnerability (e.g., upgrade to a patched version, remove an exposed version, etc.).

As yet another example, an alert generated 322 in response to a threat activity risk factor finding for a particular target entity may be transmitted to a client entity and/or the target entity including information related to the finding (e.g., explaining the activity of a malicious actor and the type of attack attempts that may follow).

As yet another example, an alert generated 322 in response to a malicious activity risk factor finding for a particular target entity may be transmitted to a client entity and/or the particular target entity including instructions to take immediate remediation action in response to the finding. The alert to the target entity may include information related to the malicious activity and instructions for how to investigate, stop, and/or remove the attack. The alert to the client entity may include information related to the malicious activity and instructions for how to ensure that the attack cannot traverse communication paths shared with the target entity.

Referring still to FIG. 5, the process 300 can include generating one or more entity cyber security risk reports 324 based on the issued 320 finding(s). A different entity cyber security risk report 324 may be generated for each of the target entities under investigation. Various information related to the findings for a particular target entity can be included in that entity's cyber security risk report 324 to help a client entity evaluate the cyber risks posed by the target entity. Thus, in some aspects, each of the entity cyber security risk reports 324 can include an overall risk assessment for the target entity. As used herein, the term “risk assessment” can refer to a score and/or another type of label or designation used to quantify cyber security risks. For example, a risk assessment can include a score (e.g., a score based on a scale of 0-100), a grade (e.g., an A-F letter grade), a pass/fail designation, and/or another type of bucketized assessment for describing cyber security risk.

In addition to, or in lieu of, the overall cyber security risk assessment, each of the cyber security risk reports 324 can include a taxonomy branch risk assessment for each of the taxonomy branches included in the cyber security risk taxonomy 306. The taxonomy branch risk assessments may be calculated and/or determined based on the findings associated with the risk factors classified under the taxonomy branch of the taxonomy branch risk assessment. For example, a target entity's IT hygiene assessment (e.g., score) may be based on issued 320 findings related to the IT hygiene branch for that entity. Calculating and/or determining risk assessments based on the cyber security risk taxonomy 306 can allow for findings related to the various risk factors to be correlated to the impact each finding has on a particular target entity's cyber security risk to a client entity. Moreover, calculating and/or determining risk assessments based on the cyber security risk taxonomy 306 enable the impact that each taxonomy branch assessment has on the overall risk assessment to be controlled (e.g., if the overall risk assessment is an overall risk score is based on 100 points, each taxonomy branch may be allotted a portion of the 100 points in order to weigh the impact each branch has on the overall score).

The entity cyber security risk reports 324 for target entities may be transmitted or otherwise made accessible to a client entity. For example, referring again to FIG. 1 and also to FIG. 5, the cyber security risk management provider server 1002 can generate an application programming interface (API) and/or a web portal to allow a client entity (e.g., entity 10101) to interact with the cyber security risk reports 324 and understand the cyber security risk posed by various target entities (e.g., 1010₂ . . . 1010ₙ). Based on a request from the client entity (e.g., entity 1010₁), the cyber security risk management provider server 1002 can be configured to generate a graphical user interface to display the cyber security risk reports 324 on a display screen (e.g., a display screen related to cyber asset 10121, etc.).

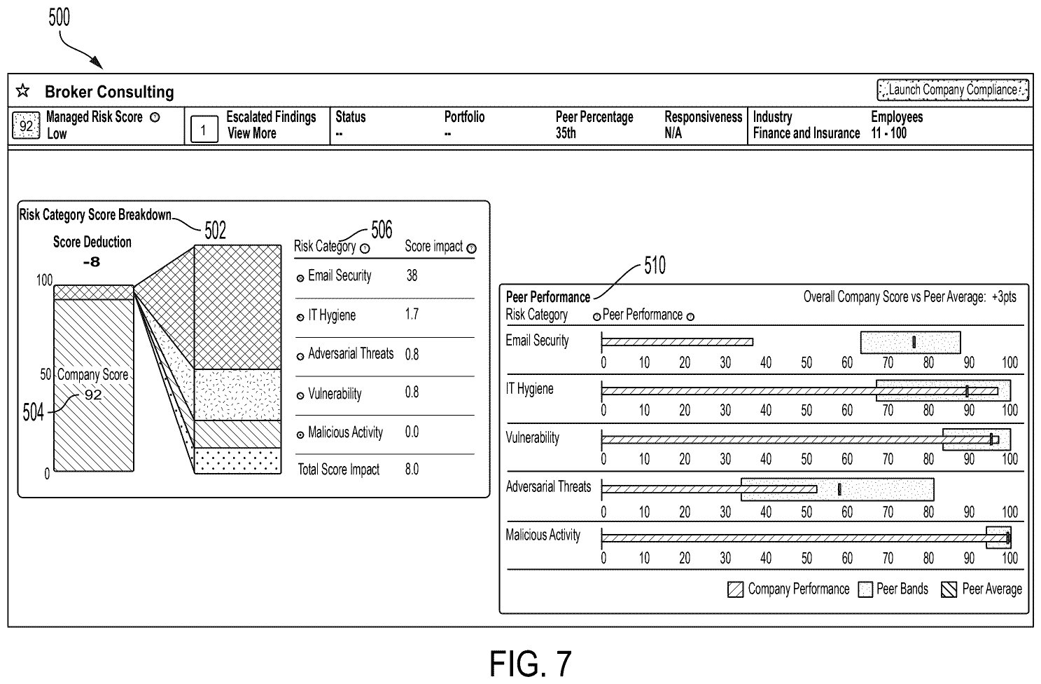

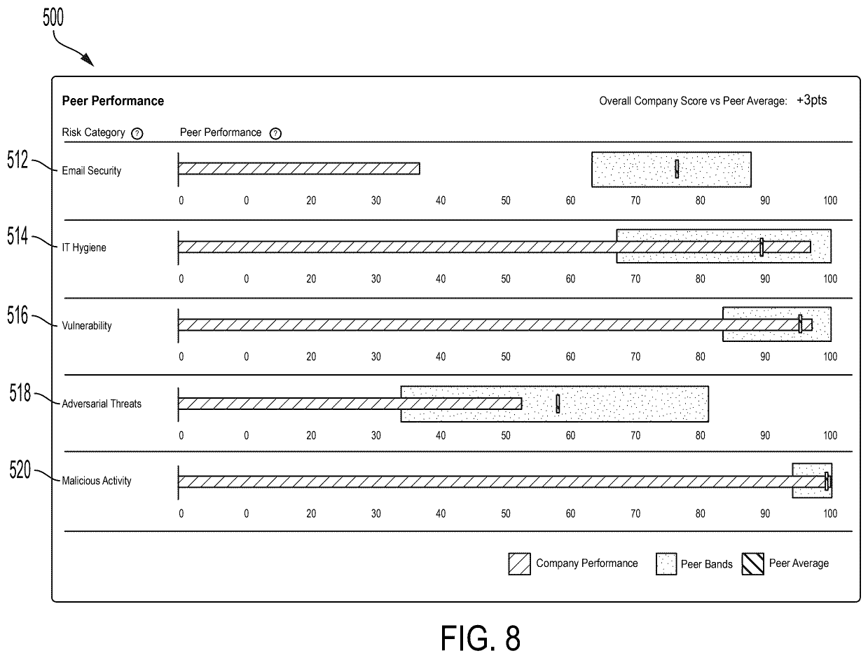

FIGS. 7 and 8 illustrate examples of a graphical user interface displaying an entity cyber security risk report for a particular target entity, in accordance with several non-limiting aspects of the present disclosure. Referring to FIG. 7, the graphical user interface 500 includes risk category score breakdown 502. Further, the risk category score breakdown 502 includes an overall score 504 for the target entity (i.e., company score) and a taxonomy branch score 506 for each branch of the risk factor taxonomy. The risk category score breakdown 502 including the overall score 504 and the taxonomy branch scores 506 is just one example of the type of risk assessments that may be implemented. In this example, the risk factor taxonomy used to evaluate the target entity includes branches for email security, IT hygiene, threat activity (adversarial threats), vulnerabilities, and malicious activities. In some aspects, the graphical user interface 500 can also display the performance of the target entity compared to other target entities (i.e., peer performance visualization 510).

FIG. 8 illustrates a detailed view of the peer performance visualization 510 displayed by graphical user interface 500 of FIG. 7. The peer performance visualization 510 includes a bar graph showing a particular target entity's (i.e., company's) taxonomy branch score performance compared to the performance of other target entities (i.e., peers). For example, the email security bar graph 512 and adversarial threats bar graph 518 shows that the target entity's performance related to email security and threats is below the average performance of other target entities whereas the IT hygiene bar graph 514, vulnerabilities bar graph 516, and malicious activity bar graph 520 shows that the target entity's performance related to email, IT hygiene, and malicious activity is greater than or equal to the average performance of other target entities. In some aspects, the performance comparison shown in the peer performance visualization 510 can be calculated based on the findings issued 320 as part of the process 300 of FIG. 5.

Referring again to FIG. 5, the process 300 can include initiating 326 remediation action(s) based on the issued 320 findings, the generated 322 alert(s), and/or the entity cyber security risk reports 324. Initiating a 326 remediation action can include instructing a client entity and/or a target entity to take action to address a deficiency related to one of the issued 320 findings. In some aspects, the initiation 326 of remediation action(s) is based on the cyber security risk taxonomy 306. In other words, the initiation 326 of remediation action(s) can be based on the classification of the risk factor associated with the issued 320 finding and/or the generated 322 alert that caused the initiation 326 of remediation action. For example, different remediation actions may be initiated 326 depending on whether the finding and/or alert that triggered the initiation of remediation action is based on a risk factor classified in the IT hygiene, vulnerabilities, threats, or malicious activities taxonomy branch.

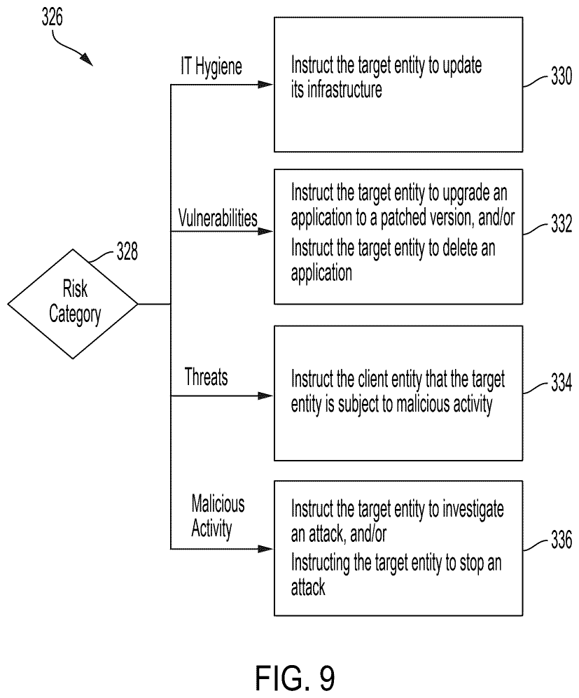

FIG. 9 illustrates a flow chart of a process for initiating 326 remediation action(s) based on a cyber security risk taxonomy that may be implemented as part of the process 300 of FIG. 5. Referring now to FIGS. 5 and 9, in one aspect, initiating 326 remediation action(s) can include determining 328 the taxonomy branch of the risk factor associated with the finding and/or the alert that caused the initiation 326 of remediation action. If the taxonomy branch of the risk factor associated with the finding and/or alert is IT hygiene, then initiating 326 remediation action(s) can include instructing 330 the target entity associated with the finding to update its IT infrastructure. If the taxonomy branch of the risk factor associated with the finding and/or alert is vulnerabilities, then initiating 326 remediation action(s) can include instructing 332 the target entity associated with the finding to upgrade an exposed application to a patched version and/or instructing the target entity associated with the finding to delete an exposed application. If the taxonomy branch of the risk factor associated with the finding and/or alert is threats, then initiating 326 remediation action(s) can include instructing 334 a client entity and/or target entity associated with the finding that the target entity is subject to malicious activity. If the taxonomy branch of the risk factor associated with the finding and/or alert is malicious activity, then initiating 326 remediation action(s) can include instructing 336 the target entity associated with the finding to investigate an attack, instructing 336 the target entity associated with the finding to stop an attack, and/or instructing 336 a client entity to adjust its communications with the target entity associated with the finding in order to prevent exposure of the client entity to an attack.

Referring now to FIG. 4, a diagram of a system 2000 configured for identifying cyber security assets and generating cyber risk mitigation actions for a plurality of entities based on a risk factor taxonomy is illustrated, in accordance with at least one non-limiting aspect of the present disclosure. The system 2000 can be similar in many respects to the system 1000 described above with respect to FIG. 1 (with corresponding reference characters representing corresponding components). For example, the system 2000 can include a cyber security risk management provider server 1002 comprising a memory 1004 and a processor 1006. The server 1002 can be configured to generate a footprinting module 1020 and a risk mitigation module 1030.

The footprinting module 1020 can be configured to execute various steps of the footprinting process 100 described above with respect to FIG. 2 and/or the step of identifying 310 entity cyber asset footprints described above with respect to FIG. 5. In some aspects, the footprinting module 1020 can include cyber asset databases 1040. The cyber asset databases 1040 can store the entity database 108 and/or the cyber asset databases 116 described above with respect to FIG. 2 and/or the entity cyber asset footprints 312 described above with respect to FIG. 5.

The risk mitigation module 1030 can be configured to execute various steps of the cyber risk mitigation process 200 described above with respect to FIG. 3 and/or various steps of the process 300 for managing cyber risk based on a risk factor taxonomy described above with respect to FIG. 5. In some aspects, the risk mitigation module 1030 can include one or more analytics module(s) 1032 and a remediation module 1041. The analytics module(s) 1032 can be configured to perform the steps of monitoring 302 cyber risk information data sources to generate source data, identifying 314 relevant observations in the source data based on correlations with entity cyber asset footprints, determining 316 if the relevant observations comply with one or more metrics, issuing 320 findings, generating 322 alerts, and/or generating entity cyber security risk reports 324 as described above with respect to FIG. 5. The remediation module 1041 can be configured to perform the step(s) of generating 322 alerts, generating entity cyber security risk reports 324, and/or initiating 326 remediation action(s) as described above with respect to FIGS. 5 and 9.

In some aspects, the risk mitigation module 1030 can include source data 1034, taxonomy 1036, and metrics 1038. The source data 1034 can store the source data 308 described above with respect to FIG. 5. The taxonomy 1036 can store information related to the cyber security risk taxonomy 306 described above with respect to FIG. 5 and/or the cyber security risk taxonomy 400 described above with respect to FIGS. 6A-6B. The metrics 1038 can store information related to the predetermined metrics 318 described above with respect to FIG. 5.

Referring again to FIG. 5, the process 300 for managing cyber risk based on a cyber security risk taxonomy 306 can provide numerous technological benefits. As explained in detail above, organizing risk factors and findings based on the cyber security risk taxonomy 306 can enable the process 300 to prioritize the generation 322 of alerts and initiation 326 of remediation activities based on different branches and/or categories of the cyber security risk taxonomy 306. Moreover, organizing the source data 308 based on the cyber security risk taxonomy allows the process 300 to be optimized to identify 314 relevant observations that are the most valuable to assessing the cyber risks associated with a plurality of target entities. Yet further, client entities receiving generated 322 alerts, entity cyber risk reports 324, and/or instructions to initiate 326 remediation action are better able to understand how different findings impact their cyber security and what actions need to be implemented to address those findings.

Still referring to FIG. 5, the process 300 for managing cyber risk based on a cyber security risk taxonomy 306 can provide technological benefits for identifying and organizing cyber risk information related to the cyber asset footprints of target entities, in a non-routine way, by (i) monitoring 302 a plurality of data sources 304 comprising cyber risk information to generate source data 308 that is organized based on a cyber security risk taxonomy 306, wherein the risk factors are classified according to taxonomy branches comprising information technology (IT) hygiene, vulnerabilities, threats, and malicious activity, and (ii) identifying 314 relevant observations in the source data by correlating the cyber risk information to the cyber asset footprints of the target entities.

Still referring to FIG. 5, the process 300 can include issuing 320 findings related to the identified 314 relevant observations and generating 322 alerts and/or cyber security risk reports 324 based on the taxonomy branch of the risk factor associated with the finding-thereby providing a specific improvement over prior cyber security risk management systems and integrating the organization of cyber risk information according to risk factors and taxonomy branches into a practical application.

Still referring to FIG. 5, the process 300 can manage cyber security risk for a client entity communicating with a plurality of target entities at a scale not practically performed by the human mind by (i) identifying 310 cyber asset footprints 312 for the target entities, (ii) monitoring 302 a plurality of data sources 304 comprising cyber risk information to generate source data 308, and (iii) identifying 314 relevant observations in the source data 308 by correlating cyber risk information in the source data to one of the cyber asset footprints 312.

Referring to FIGS. 5 and 6, the process 300 can provide technological benefits by initiating 326 remediation actions based on the taxonomy branch of the cyber security risk taxonomy 306, 400 associated with the issued 320 finding-thereby providing a specific improvement over prior cyber security risk management systems and integrating the organization of cyber risk information according to risk factors and taxonomy branches into a practical application. For example, although various “risk rating solutions” exist for evaluating cyber risk related to a target entity, such as those described in U.S. Pat. No. 9,294,498, titled ONLINE PORTAL FOR IMPROVING CYBERSECURITY RISK SCORES, issued Mar. 22, 2016, which is incorporated by reference herein to the extent that it does not conflict with the present disclosure, these risk rating solutions generally fail to provide a remediation lever in response to identifying cyber-related risks. This may be because the various categories of cyber risks used by risk rating solutions can make it difficult to determine what remediation action should be implemented in response to an identified risk. Conversely, the taxonomy branches and risk categories of the cyber security risk taxonomy 306, 400 can enable specific remediation actions to be implemented in response to an identified risk.

As one example, risk rating solutions may employ a “social engineering” category to determine the potential susceptibility of an entity to a targeted social engineering attack. However, this social engineering category may fail to distinguish between successful attacks and attempted attacks. Thus, it may be difficult for an entity receiving a score related to “social engineering” to understand how cyber risks related to this score should be addressed. Conversely, the cyber security risk taxonomy 306, 400 can include separate branches for threat activity and malicious activity. Thus, the cyber security risk taxonomy 306, 400 can enable the initiation 326 of different types of remediation actions depending on whether an identified cyber risk is related to threat activity or malicious activity (e.g., initiating immediate action to remediate an attack in the case of malicious activity versus simply alerting an entity that an attack was attempted in the case of threats).

As another example, risk rating solutions may employ a “malware and botnet infection” category to detect malware and botnet “events.” However, this malware and botnet infection category may fail to distinguish between attempted and successful botnet “events.” Conversely, the cyber security risk taxonomy 306, 400 can include separate risk categories 404 for successful attacks (e.g., outbound adversarial infections under the malicious activity branch 402) and attempted attacks (e.g., inbound adversarial probing under the threat activity branch 402). Thus, similar to the above, the cyber security risk taxonomy 306, 400 can enable the initiation 326 of different types of remediation actions depending on whether an identified cyber risk is related to threat activity or malicious activity (e.g., initiating immediate action to remediate an attack in the case of malicious activity versus simply alerting an entity that an attack was attempted in the case of threat activity).

As yet another example, risk rating solutions may employ a “DNS health” category to measure the health and configuration of an entity's DNS settings and to validate that no malicious events occurred in the passive DNS history of an entity's network. However, this DNS health category score may fail to distinguish between configurations that do not comply with industry cyber security standards and successful attacks. Conversely, the cyber security risk taxonomy 306, 400 can include separate risk categories 404 for IT hygiene-related configuration deficiencies (e.g., email, DNS security under the IT hygiene branch 402) and successful attacks (e.g., outbound adversarial interactions, external traffic anomalies under the malicious activity branch 402). Thus, the cyber security risk taxonomy 306, 400 can enable the initiation 326 of different types of remediation actions depending on whether an identified cyber risk is related to successful malicious activity (e.g., initiating immediate action to remediate an attack) or an IT hygiene deficiency (e.g., with a lower sense of urgency, instructing an entity to implement a configuration update).

Referring now to FIG. 10, a diagram of an example cloud architecture 8000 is illustrated, in accordance with at least one non-limiting aspect of the present disclosure. The cloud architecture 8000 and the various components comprised therein, as described below, may be used to implement the server 1002 described hereinabove in connection with FIGS. 1 and 4 and/or may be used to store and execute instructions for any of the various process described hereinabove in connection with FIGS. 2-3 and 5-9. The definitions provided in “The NIST Definition of Cloud Computing” by Peter Mell and Tim Grance, dated September 2011, which is incorporated herein by reference in its entirety, are applicable to the discussion accompanying FIG. 10.

According to the non-limiting aspect of FIG. 10, the cloud architecture 8000 is configured to enable on-demand network access to a shared pool of computing resources. In this regard, the cloud architecture 8000 can be deployed as a private cloud provisioned for exclusive use by a single organization (e.g., cyber risk management provider), a community cloud provisioned for use by a specific community of users (e.g., including a cyber risk management provider, a client entity, etc.), a public cloud, or a hybrid cloud.

The cloud architecture 8000 can include an infrastructure 8100. The infrastructure can include physical hardware such as a compute pool 8110 and/or a storage pool 8120. The compute pool 8110 and storage pool 8120 comprise a series of servers (e.g., similar to computer system 9000 of FIG. 11) that provide computing and storage resources for the cloud architecture 8000. Infrastructure 8100 can also include an abstraction layer 8130 and an orchestration layer 8140. The abstraction layer 8130 is provided to abstract (e.g., via virtualization) the resources of physical hardware, and the orchestration layer 8140 is provided to pool the abstracted resources. The pooled resources can be provisioned by the orchestration layer 8140 to execute the various functions required by various users of the cloud architecture 8000. For example, pooled resources of the cloud architecture 8000 and/or infrastructure 8100 can be provisioned to carry out the processes 100, 200, 300 described herein.

In some aspects, the cloud architecture 8000 can include an application platform 8200 comprising any number of applications 8210₁, 8210₂, 8210₃ . . . 8210ₙ. Pooled resources of the underlying infrastructure 8100 can be provisioned to the application platform 8200 to generate executable applications 8210₁, 8210₂, 8210₃ . . . 8210ₙ. In some aspects, one or more of the applications 8210₁, 8210₂, 8210₃ . . . 8210ₙ can be employed to carry out the processes 100, 200, 300 described herein. For example, one or more of the applications 8210₁, 8210₂, 8210₃ . . . 8210, may be employed as the footprinting module 1020, the risk mitigation module 1030, the analytics module(s) 1032, and/or the remediation module 1041 described above with respect to FIG. 4.

Referring now to FIG. 11, a diagram of a computer system 9000 is illustrated, in accordance with at least one non-limiting aspect of the present disclosure. The computer system 9000 and the various components comprised therein, as described below, may be used to implement various components of the systems 1000, 2000 and cloud architecture 8000 described hereinabove in connection with FIGS. 1, 4, and 10 and/or may be used to store and execute instructions for any of the various process described hereinabove in connection with FIGS. 2-3 and 5-9.

According to the non-limiting aspect of FIG. 11, the computer system 9000 may include a bus 9002 (i.e., interconnect), one or more processors 9004, a main memory 9006, read-only memory 9008, removable storage media 9010, mass storage 9012, and one or more communications ports 9014. As should be appreciated, components such as removable storage media are optional and are not necessary in all systems. Communication port 9014 may be connected to one or more networks by way of which the computer system 9000 may receive and/or transmit data.

As used herein, a “processor” can mean one or more microprocessors, central processing units (CPUs), computing devices, microcontrollers, digital signal processors, graphics processing units (GPUs) or like devices or any combination thereof, regardless of their architecture. An apparatus that performs a process can include, e.g., a processor and those devices, such as input devices and output devices, that are appropriate to perform the process.

Processor(s) 9004 can be any known processor, such as, but not limited to, processors manufactured by and/or sold by INTEL®, AMD®, or MOTOROLA®, and the like, that are generally well known to one skilled in the relevant art and are well defined in the literature. Communications port(s) 9014 can be any of an RS-232 port for use with a modem-based dial-up connection, a 10/100 Ethernet port, a gigabit port using copper or fiber, a universal serial bus (USB) port, and the like. Communications port(s) 9014 may be chosen depending on a network such as a Local Area Network (LAN), a Wide Area Network (WAN), a CDN, or any network to which the computer system 9000 connects. The computer system 9000 may be in communication with peripheral devices (e.g., display screen 9016, input device(s) 9018) via Input/Output (I/O) port 9020.

Main memory 9006 can be Random Access Memory (RAM), or any other dynamic storage device(s) commonly known in the art. Read-only memory 9008 can be any static storage device(s), such as Programmable Read-Only Memory (PROM) chips for storing static information such as instructions for processor 9004. Mass storage 9012 can be used to store information and instructions. For example, hard disks such as the Adaptec® family of Small Computer Serial Interface (SCSI) drives; an optical disc; an array of disks, such as redundant array of independent disks (RAID), such as the Adaptec® family of RAID drives; or any other mass-storage devices may be used.

Bus 9002 communicatively couples processor(s) 9004 with the other memory, storage, and communications blocks. Bus 9002 can be a PCI/PCI-X, SCSI, a Universal Serial Bus (USB) based system bus, (or other) depending on the storage devices used and the like. Removable storage media 9010 can be any kind of external hard drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Aspects described herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) that may be read by a computer, a processor, or a like device. Such a medium may take many forms, including, but not limited to, non-volatile media, volatile media, and transmission media. Non-volatile media can include, for example, optical or magnetic disks and other persistent memory. Volatile media can include dynamic random access memory, which typically constitutes the main memory of the computer. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, read-only memories (ROMs), RAMS, erasable programmable read-only memories (EPROMs), electrically erasable programmable read-only memories (EEPROMs), magnetic or optical cards, flash memory, or other type of media/machine-readable medium suitable for storing electronic instructions. Moreover, aspects described herein may also be downloaded as a computer program product, wherein the program may be transferred from a remote computer to a requesting computer by way of data signals embodied in a carrier wave or other propagation medium via a communication link (e.g., modem or network connection).

Various forms of computer-readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art. A computer-readable medium can store (in any appropriate format) those program elements that are appropriate to perform the methods.

As shown, main memory 9006 is encoded with application(s) 9022 that support the functionality discussed herein (the application 9022 may be an application that provides some or all of the functionality of the CD services described herein, including the client application). Application(s) 9022 (and/or other resources as described herein) can be embodied as software code, such as data and/or logic instructions (e.g., code stored in the memory or on another computer-readable medium such as a disk) that supports processing functionality according to different aspects described herein.

During operation of one aspect, processor(s) 9004 accesses main memory 9006 via the use of bus 9002 in order to launch, run, execute, interpret, or otherwise perform the logic instructions of the application(s) 9022. Execution of application(s) 9022 produces processing functionality of the service related to the application(s). In other words, the process(es) 9024 represents one or more portions of the application(s) 9022 performing within or upon the processor(s) 9004 in the computer system 9000.

It should be noted that, in addition to the process(es) 9024 that carries (carry) out operations as discussed herein, other processes described herein include the application 9022 itself (i.e., the unexecuted or non-performing logic instructions and/or data). The application 9022 may be stored on a computer-readable medium (e.g., a repository) such as a disk or in an optical medium. According to other aspects, the application 9022 can also be stored in a memory-type system, such as in firmware, ROM, or, as in this example, as executable code within the main memory 9006 (e.g., within RAM). For example, application 9022 may also be stored in removable storage media 9010, read-only memory 9008, and/or mass storage device 9012.

Those skilled in the art will understand that the computer system 9000 can include other processes and/or software and hardware components, such as an OS that controls allocation and use of hardware resources.

Various aspects of the subject matter described herein are set out in the following numbered clauses:

Clause 1: A method for managing cyber security risk for a client entity communicating with a plurality of target entities, the method comprising: identifying a plurality of cyber asset footprints, wherein each cyber asset footprint comprises cyber assets associated with a different one of the target entities; monitoring a plurality of data sources comprising cyber security risk information to generate source data, wherein the source data is organized based on a plurality of risk factors, and wherein the risk factors are classified according to taxonomy branches comprising: information technology (IT) hygiene; vulnerabilities; threat activity; and malicious activity; identifying relevant observations in the source data, wherein each relevant observation comprises information related to one the risk factors, and wherein each relevant observation is identified based on a correlation between the information related to the risk factor and one of the cyber asset footprints; determining that one of the relevant observations does not comply with a predetermined metric of a plurality of predetermined metrics, wherein each of the predetermined metrics is associated with one of the cyber security risk factors; issuing a finding based on determining the relevant observation does not comply with the predetermined metric, wherein the finding includes a criticality, and wherein the criticality is based on the taxonomy branch of the risk factor associated with the finding; and transmitting an alert to the client entity based on the criticality of the finding.

Clause 2: The method of clause 1, further comprising initiating a remediation action for the target entity associated with the finding in response to issuing the finding.

Clause 3: The method of any of clauses 1-2, further comprising: determining, for each of the relevant observations, whether the relevant observation fails to comply with at least one of the predetermined metrics; issuing findings based on determining whether each of the relevant observations fails to comply with at least one of the predetermined metrics; and generating a risk report for each of the target entities based on the findings.

Clause 4: The method of any of clauses 1-3, wherein generating the risk report for each of the target entities based on the findings comprises: determining which of the findings are associated with the target entity; and determining, for the target entity, a taxonomy branch risk assessment for each of the taxonomy branches, wherein each taxonomy risk assessment is based on the findings associated with the cyber security risk factors classified under the taxonomy branch of the taxonomy branch risk assessment.

Clause 5: The method of any of clauses 1-4, wherein generating the risk report for each of the target entities further comprises: determining an overall risk assessment for the target entity based on the taxonomy branch risk assessments.

Clause 6: The method of any of clauses 1-5, initiating a remediation action for at least one of the target entities based on the generated risk reports.

Clause 7: The method of any of clauses 1-6, further comprising: classifying the risk factors according to risk categories; and classifying the risk categories according to the taxonomy branches.

Clause 8: The method of any of clauses 1-7, wherein the risk categories classified in the IT hygiene taxonomy branch comprise at least one of: an attack surface-related risk factor; an email security-related risk factor; a configuration-related risk factor; an application security-related risk factor; a DNS security-related risk factor; a non-business application-related risk factor; and a vendor dependency-related risk factor.

Clause 9: The method of any of clauses 1-8, wherein the risk categories classified in the vulnerabilities taxonomy branch comprise at least one of: a software vulnerability-related risk factor; and a data encryption-related risk factor.

Clause 10: The method of any of clauses 1-9, wherein the risk categories classified in the threat activity taxonomy branch comprise at least one of: an inbound adversarial probing-related risk factor; a phish targeting-related risk factor; a credential targeting-related risk factor; and a Dark Web-related risk factor.

Clause 11: The method of any of clauses 1-10, wherein the risk categories classified in the malicious activity taxonomy branch comprise at least one of: an outbound adversarial interaction-related risk factor; a phish exploitation-related risk factor; a blacklisted asset-related risk factor; an external traffic abnormality-related risk factor; a breach-related risk factor; and a credential exploitation-related risk factor.

Clause 12: The method of any of clauses 1-11, wherein the alert is transmitted based on the risk factor associated with the finding being classified in the vulnerabilities taxonomy branch, the method further comprising: initiating a remediation action for the target entity associated with the finding based on the alert, wherein the initiating the remediation action for the target entity comprises at least one of: instructing the target entity to upgrade an application to a patched version; and instructing the target entity to delete an application.

Clause 13: The method of any of clauses 1-12, wherein the alert is transmitted based on the risk factor associated with the finding being classified in the threat activity taxonomy branch, and wherein the alert comprises instructions to the client entity that the target entity is subject to potentially malicious activity.

Clause 14: The method of any of clauses 1-13, wherein the alert is transmitted based on the risk factor associated with the finding being classified in the malicious activity taxonomy branch, the method further comprising: initiating, based on the alert, a remediation action for the target entity associated with the finding, wherein the initiating the remediation action for the target entity comprises at least one of: instructing the target entity to investigate an attack; and instructing the target entity to stop an attack.

Clause 15: The method of any of clauses 1-14, wherein the alert is transmitted based on the risk factor associated with the finding being classified in the IT hygiene taxonomy branch, the method further comprising: initiating, based on the alert, a remediation action for the target entity associated with the finding, wherein the initiating the remediation action for the target entity comprises instructing the target entity to update or otherwise modify its infrastructure.

Clause 16: A method for managing cyber security risk for a client entity communicating with a plurality of target entities, the method comprising: identifying a plurality of cyber asset footprints, wherein each cyber asset footprint comprises cyber assets associated with a different one of the target entities; monitoring a plurality of data sources comprising cyber risk information to generate source data, wherein the source data is organized based on a plurality of risk factors, and wherein the risk factors are classified according to a cyber security risk taxonomy; identifying relevant observations in the source data, wherein each relevant observation comprises information related to one the risk factors, and wherein each relevant observation is identified based on a correlation between the information related to the risk factor and one of the cyber asset footprints; determining that one of the relevant observations does not comply with a predetermined metric of a plurality of predetermined metrics, wherein each of the predetermined metrics is associated with one of the risk factors; and issuing a finding based on determining the relevant observation does not comply with the predetermined metric, wherein the finding includes a criticality, and wherein the criticality is based on the classification of the risk factor associated with the finding.

Clause 17: The method of clause 16, wherein the cyber security risk taxonomy comprises taxonomy branches, and wherein the taxonomy branches include at least one of: email; information technology (IT) hygiene; vulnerabilities; threat activity; and malicious activity.

Clause 18: The method of any of clauses 16-17, initiating a remediation action based on the criticality of the finding.

Clause 19: The method of any of clauses 16-18, further comprising: generating an alert based on the finding.

Clause 20: The method of any of clauses 16-19, further comprising at least one of: transmitting the alert to the target entity associated with the finding; and transmitting the alert to a client entity.

Clause 21: A system and method for cyber security risk mitigation substantially as disclosed and described herein.

All patents, patent applications, publications, or other disclosure material mentioned herein are hereby incorporated by reference in their entirety as if each individual reference was expressly incorporated by reference respectively. All references, and any material or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary and illustrative aspects have been described. The aspects described herein are understood as providing illustrative features of varying detail of various aspects of the present disclosure, and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims), are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

As used herein, the singular form of “a,” “an,” and “the” include the plural references unless the context clearly dictates otherwise.

Directional phrases used herein, such as, for example, “and without limitation,” “top,” “bottom,” “left,” “right,” “lower,” “upper,” “front,” “back,” and variations thereof, shall relate to the orientation of the elements shown in the accompanying drawing, and they are not limiting upon the claims unless otherwise expressly stated.

The terms “about” or “approximately” as used in the present disclosure, unless otherwise specified, mean an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed on any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a system that “comprises,” “has,” “includes,” or “contains” one or more elements possesses those one or more elements, but it is not limited to possessing only those one or more elements. Likewise, an element of a system, device, or apparatus that “comprises,” “has,” “includes,” or “contains” one or more features possesses those one or more features, but it is not limited to possessing only those one or more features.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skilled in the art in light of this disclosure. In addition, those skilled in the art will appreciate that the mechanisms of the subject matter described herein are capable of being distributed as one or more program products in a variety of forms and that an illustrative form of the subject matter described herein applies regardless of the particular type of signal-bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus, a machine-readable medium may include any mechanism for storing or transmitting information in a form readable by a machine (e.g., a computer), including, but not limited to: floppy diskettes, optical disks, CD-ROMs, magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical, or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application-specific integrated circuit, electrical circuitry forming a general-purpose computing device configured by a computer program (e.g., a general-purpose computer configured by a computer program that at least partially carries out processes and/or devices described herein, or a microprocessor configured by a computer program that at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions or instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states that may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms, may be associated with the appropriate physical quantities, and they are merely convenient labels applied to these quantities and/or states.

1. A method for managing cyber security risk for a client entity communicating with a plurality of target entities, the method comprising:
identifying a plurality of cyber asset footprints, wherein each cyber asset footprint comprises cyber assets associated with a different one of the target entities;
monitoring a plurality of data sources comprising cyber risk information to generate source data, wherein the source data is organized based on a plurality of risk factors, and wherein the risk factors are classified according to taxonomy branches comprising:
information technology (IT) hygiene;
vulnerabilities;
threat activity; and
malicious activity;
identifying relevant observations in the source data, wherein each relevant observation comprises information related to one the risk factors, and wherein each relevant observation is identified based on a correlation between the information related to the risk factor and one of the cyber asset footprints;
determining that one of the relevant observations does not comply with a predetermined metric of a plurality of predetermined metrics, wherein each of the predetermined metrics is associated with one of the risk factors;
issuing a finding based on determining the relevant observation does not comply with the predetermined metric, wherein the finding includes a criticality, and wherein the criticality is based on the taxonomy branch of the risk factor associated with the finding; and
transmitting an alert to the client entity based on the criticality of the finding.

2. The method of claim 1, further comprising:
initiating a remediation action for the target entity associated with the finding in response to issuing the finding.

3. The method of claim 1, further comprising:
determining, for each of the relevant observations, whether the relevant observation fails to comply with at least one of the predetermined metrics;
issuing findings based on determining whether each of the relevant observations fails to comply with at least one of the predetermined metrics; and
generating a risk report for each of the target entities based on the findings.

4. The method of claim 3, wherein generating the risk report for each of the target entities based on the findings comprises:
determining which of the findings are associated with the target entity; and
determining, for the target entity, a taxonomy branch risk assessment for each of the taxonomy branches, wherein each taxonomy branch risk assessment is based on the findings associated with the risk factors classified under the taxonomy branch of the taxonomy branch risk assessment.

5. The method of claim 4, wherein generating the risk report for each of the target entities further comprises:
determining an overall risk assessment for the target entity based on the taxonomy branch risk assessments.

6. The method of claim 5, further comprising:
initiating a remediation action for at least one of the target entities based on the generated risk reports.

7. The method of claim 1, further comprising:
classifying the risk factors according to risk categories; and
classifying the risk categories according to the taxonomy branches.

8. The method of claim 7, wherein the risk categories classified in the IT hygiene taxonomy branch comprise at least one of:
an attack surface-related risk factor;
an email security-related risk factor;
a configuration-related risk factor;
an application security-related risk factor;
a DNS security-related risk factor;
a non-business application-related risk factor; or
a vendor dependency-related risk factor.

9. The method of claim 7, wherein the risk categories classified in the vulnerabilities taxonomy branch comprise at least one of:
a software vulnerability-related risk factor; or
a data encryption-related risk factor.

10. The method of claim 7, wherein the risk categories classified in the threat activity taxonomy branch comprise at least one of:
an inbound adversarial probing-related risk factor;
a phish targeting-related risk factor;
a credential targeting-related risk factor; or
a Dark Web-related risk factor.

11. The method of claim 7, wherein the risk categories classified in the malicious activity taxonomy branch comprise at least one of:
an outbound adversarial interaction-related risk factor;
a phish exploitation-related risk factor;
a blacklisted asset-related risk factor;
an external traffic abnormality-related risk factor;
a breach-related risk factor; or
a credential exploitation-related risk factor.

12. The method of claim 1, wherein the alert is transmitted based on the risk factor associated with the finding being classified in the vulnerabilities taxonomy branch, the method further comprising:
initiating a remediation action for the target entity associated with the finding based on the alert, wherein the initiating the remediation action for the target entity comprises at least one of:
instructing the target entity to upgrade an application to a patched version; and
instructing the target entity to delete an application.

13. The method of claim 1, wherein the alert is transmitted based on the risk factor associated with the finding being classified in the threat activity taxonomy branch, and wherein the alert comprises instructions to the client entity that the target entity is subject to malicious activity.

14. The method of claim 1, wherein the alert is transmitted based on the risk factor associated with the finding being classified in the malicious activity taxonomy branch, the method further comprising:
initiating, based on the alert, a remediation action for the target entity associated with the finding, wherein the initiating the remediation action for the target entity comprises at least one of:
instructing the target entity to investigate an attack; and
instructing the target entity to stop an attack.

15. The method of claim 1, wherein the alert is transmitted based on the risk factor associated with the finding being classified in the IT hygiene taxonomy branch, the method further comprising:
initiating, based on the alert, a remediation action for the target entity associated with the finding, wherein the initiating the remediation action for the target entity comprises instructing the target entity to update its infrastructure.

16. A method for managing cyber security risk for a client entity communicating with a plurality of target entities, the method comprising:
identifying a plurality of cyber asset footprints, wherein each cyber asset footprint comprises cyber assets associated with a different one of the target entities;
monitoring a plurality of data sources comprising cyber risk information to generate source data, wherein the source data is organized based on a plurality of risk factors, and wherein the risk factors are classified according to a cyber security risk taxonomy;
identifying relevant observations in the source data, wherein each relevant observation comprises information related to one the risk factors, and wherein each relevant observation is identified based on a correlation between the information related to the risk factor and one of the cyber asset footprints;
determining that one of the relevant observations does not comply with a predetermined metric of a plurality of predetermined metrics, wherein each of the predetermined metrics is associated with one of the risk factors; and
issuing a finding based on determining the relevant observation does not comply with the predetermined metric, wherein the finding includes a criticality, and wherein the criticality is based on the classification of the risk factor associated with the finding.

17. The method of claim 16, wherein the cyber security risk taxonomy comprises taxonomy branches, and wherein the taxonomy branches include at least one of:
email;
information technology (IT) hygiene;
vulnerabilities;
threat activity; or
malicious activity.

18. The method of claim 16, further comprising:
initiating a remediation action based on the criticality of the finding.

19. The method of claim 16, further comprising:
generating an alert based on the finding.

20. The method of claim 19, further comprising at least one of:
transmitting the alert to the target entity associated with the finding; and
transmitting the alert to a client entity.
